(19) United States
(12) Patent Application Publication
(10) Pub. No.: US 2026/0236342 A1
(43) Pub. Date: Aug. 13, 2026

(54) METHOD AND SYSTEM FOR GENERATING CYBERSECURITY VULNERABILITY REMEDIATION USING GENERATIVE AI

(71) Applicant: ObjectSecurity LLC, San Diego, CA (US)

(72) Inventors: Ulrich LANG, San Diego, CA (US); Jason KRAMER, Studio City, CA (US); Trevor THOMAS, Verona, WI (US); Colin GENTA, Portsmouth, NH (US); Hud WAHAB, Fort Collins, CO (US)

(73) Assignee: ObjectSecurity LLC, San Diego, CA (US)

(21) Appl. No.: 19/535,555

(22) Filed: Feb. 10, 2026

Related U.S. Application Data
(60) Provisional application No. 63/756,363, filed on Feb. 10, 2025.

(51) Int. Cl. G06F 11/07; G06F 8/41; G06F 21/57

(52) U.S. Cl. CPC G06F 11/0793; G06F 8/433; G06F 21/577; G06F 2221/033

(57) ABSTRACT

Method and system for generating cybersecurity vulnerability remediation using generative AI, including loading software files; receiving input data associated with configuration settings and preferences; modifying the structure of the loaded software files for analysis agent ensembles; executing iterations of analysis agent ensembles on the modified software files using the received user input data; identifying potential software issues found through execution of iterations of analysis agent ensembles on the modified software files; determining options to remediate the potential software issues through automated updates, guided remediation steps, or a combination thereof; and delivering potential software issues and options to remediate the potential software issues to output interfaces.

This application claims priority to U.S. Provisional Application No. 63/756,363 entitled “Method and System for Generating Cybersecurity Vulnerability Remediation Using Generative AI”, which was filed on Feb. 10, 2025, and which is incorporated herein by reference.

This invention was made with government support under HDTRA124C0037 awarded by the Defense Threat Reduction Agency (DTRA). The government has certain rights in the invention.

### BACKGROUND OF THE INVENTION

### 1. Field of the Invention

The present disclosure relates generally to automated software analysis using artificial intelligence. More specifically, the disclosure relates to systems and methods for employing agentic Large Language Model (LLM) ensembles to ingest software files from diverse data sources, identify technical vulnerabilities or quality issues, and generate corresponding remediation guidance for distribution to various notification sinks.

### 2. Description of the Related Art

Software systems frequently contain cybersecurity vulnerabilities, misconfigurations, and/or code quality defects that may be introduced during software development, integration of third-party components, configuration, installation, and/or deployment. Conventional techniques for identifying such defects include automated security testing tools, such as static application security testing (SAST), dynamic application security testing (DAST), software composition analysis (SCA), and/or software bill of materials (SBOM) generation. While these techniques can identify potential issues, they often produce large volumes of false positives, incomplete and/or noisy results, and/or limited and/or non-actionable guidance regarding mitigation and/or remediation.

Recent advances in artificial intelligence and/or machine learning (AI/ML), particularly large language models (LLMs), have created new opportunities to improve software analysis and/or remediation. LLMs are capable of processing large volumes of textual and/or structured data, such as source code, configuration files, and/or documentation, and/or can reason about semantic relationships across disparate portions of a software system. As a result, LLMs have been explored in academic research and/or commercial products for tasks such as vulnerability detection, vulnerability explanation, remediation recommendation, automated code modification, multi-agent orchestration, and/or integration into developer workflows (e.g., CI/CD pipelines, integrated development environments, and/or code review systems).

Despite these advancements, existing conventional and/or AI-based approaches remain limited in scope and/or flexibility. In particular, there are no known systems—whether traditional or LLM-based—that combine, in a unified and configurable architecture: (i) the ability to analyze multiple disparate software file formats, including binary files, source code files, configuration files, build artifacts, and/or related data, either individually or in relation to one another; (ii) the ability to navigate and/or reason over large repositories, directory structures, and/or collections of software files; (iii) configurable, automated, and/or event-driven software ingestion from heterogeneous data sources; (iv) configurable, automated dissemination of detected software issues to a wide variety of notification data sinks; and/or (v) automated selection and orchestration of multiple analysis agent ensembles, including the ability for users and/or systems to override and/or influence ensemble selection. These limitations motivate improved systems and/or methods for generative AI-based cybersecurity vulnerability remediation.

### SUMMARY OF THE INVENTION

Herein are some examples of how the invention may be implemented. Note this list is not exhaustive, and the invention may be created in some other manner similar in function, but not within the example's exact specification. It is therefore an object of the invention to provide one or more of the following:
ingestion of one or more software files from one or more software file data sources prior to and/or during agentic analysis. Ingested software files may be persistently stored and/or made available to subsequent system components and/or processing steps via an analysis file storage mechanism. Software ingestion may further include zero or more preprocessing operations, including but not limited to restructuring ingested software files and/or directories, filtering specific files and/or folders, and/or other preparatory transformations.
a method of user interaction comprising the configuration of event settings. Event settings may govern, for example, which software file data sources are ingested from, when such ingestion occurs, and/or under what conditions ingestion is initiated.
agentic analysis performed in whole or in part by one or more analysis agent ensembles. Analysis agent ensembles may differ in implementation details, constituent components, and/or processing order. Such ensembles may include, but are not limited to, components such as LLM interfaces, software analysis tools, message histories, retrieval-augmented generation (RAG) pipelines, decompilation processes, call graph construction mechanisms, and/or similar analysis techniques. Agentic analysis may be performed in a single pass of the ingested software files or in multiple passes.
a method of user interaction with one or more analysis agent ensembles that may influence or control the behavior of agentic analysis. Such interaction may include, but is not limited to, the creation of messages within a message history, the specification of system prompts and/or initial user prompts, enabling or disabling software analysis tools, configuring software analysis tool parameters, defining analysis completion criteria, and/or overriding a default analysis agent ensemble selection.
generation (i.e., identifying, detecting, inferring, reporting etc.) of zero or more software issues during and/or after agentic analysis. Software issues may include, but are not limited to, cybersecurity vulnerabilities, code quality defects, and/or related findings. Software issues may incorporate supplementary data such as descriptions, titles, summaries, code excerpts, patched and/or remediated code, mitigation and/or remediation guidance, severity classifications, and/or related metadata, some or all of which may be generated in whole or in part by one or more LLM interfaces. Software issues may be persistently stored for subsequent processing, review, and/or presentation.
generation of zero or more notifications in response to detected software issues during and/or after agentic analysis. Notifications may reference one or more software issues and/or may undergo zero or more processing and/or formatting steps prior to delivery. Notifications may be distributed to one or more notification data sinks, including but not limited to user interfaces, project management systems, communication platforms, integrated development environments (IDEs), and/or similar systems.
a method of user interaction comprising the configuration of notification settings. Notification settings may control, for example, which notification data sinks receive notifications, when notifications are distributed, and/or what processing and/or formatting operations are applied to notifications and/or how such operations are performed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. For example, singular or plural use of terms are illustrative only and may include zero, one, or multiple; the use of “may” signifies options; modules, steps and stages can be reordered, present/absent, single, or multiple etc.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 depicts an example system architecture diagram where a user(s) may configure the generative AI-based cybersecurity vulnerability remediation system to ingest software file data, perform agentic analysis, and/or yield notifications;

FIG. 2 depicts an example functional diagram for ingesting, preprocessing, and/or storing analysis files from one or more software files data sources;

FIG. 3 depicts an example functional diagram for an analysis agent ensemble focused on using file navigation-based tools;

FIG. 4 depicts an example functional diagram for an analysis agent ensemble focused on using Retrieval Augmented Generation (RAG);

FIG. 5 depicts an example functional diagram for an analysis agent ensemble focused on scanning software functions;

FIG. 6 depicts an example functional diagram for augmenting an LLM interface with one or more software analysis tools in the context of an analysis agent ensemble;

FIG. 7 depicts an example functional diagram for code and/or software function pre-processing in the context of an analysis agent ensemble;

FIG. 8 depicts an example functional diagram for software file decompilation in the context of an analysis agent ensemble;

FIG. 9 depicts an example functional diagram for formatting and forwarding zero or more software issues to zero or more notification data sinks as notifications;

FIG. 10 depicts an example functional diagram for remediating code using an analysis agent ensemble that uses symbolic execution;

FIG. 11 depicts an example UI for a home page and/or agentic analysis entry point;

FIG. 12 depicts an example UI for an analysis chat and/or issue detail view;

FIG. 13 depicts an example UI for event setting configuration;

FIG. 14 depicts an example UI for notification setting configuration;

FIG. 15 depicts an example flowchart for a generative AI-based cybersecurity vulnerability remediation method wherein software ingestion, agentic analysis, and/or notifications may be performed.

### DETAILED DESCRIPTION

### Terminology

Agentic Analysis-A process in which one or more analysis agent ensembles analyze one or more software files and identify, detect, and/or report zero or more software issues.

Analysis Agent Ensemble and/or just “Ensemble” A collection of one or more software components and/or modules configured to analyze one or more software files and to identify, detect, and/or report zero or more software issues. The components of an ensemble may include, but are not limited to, one or more LLM interfaces, message histories, zero or more software analysis tools, pre-processing components, post-processing components, persistent data storage mechanisms, etc. An analysis agent ensemble may be implemented in a variety of architectures, including but not limited to ensembles focused on file-navigation-based analysis, retrieval-augmented generation (RAG), iterative function analysis, control-flow analysis, data-flow analysis, any combinations thereof, etc. Zero or more user(s) may influence and/or control the behavior of an analysis agent ensemble by interacting with one or more ensemble components. Such interactions may include, but are not limited to, creating, updating, and/or otherwise modifying messages within a message history; configuring aspects of an LLM interface, such as selecting a particular LLM provider and/or model; enabling and/or disabling specific software analysis tools; configuring parameters for one or more software analysis tools; etc.

Software File—A computer-readable file and/or folder that may be analyzed by an analysis agent ensemble to identify, detect, and/or report zero or more software issues. Software files include, but are not limited to, binary files, source code files, intermediate representations, vulnerability database records, compressed archives, configuration files, build artifacts, metadata files, etc.

Binary File—A type of software file comprising executable and/or interpretable machine-level instructions. Binary files include but are not limited to executable machine code (e.g., x86, ARM, MIPS, RISC-V, etc.), dynamically linked libraries (e.g., .dll, .so, etc.), statically linked executables, firmware images, bytecode, etc.

Source Code File-A type of software file comprising human-readable text that specifies instructions, declarations, and/or expressions for processing by a computer system, including compilation, interpretation, and/or assembly into an executable and/or interpretable computer program. Source code files may be written in one or more programming languages, including but not limited to C, C++, BASIC, Java, Pascal, Python, PHP, Ruby, Bash, Perl, Prolog, Datalog, Scala, Haskell, Rust, assembly language, etc.

Intermediate Representation—A type of software file and/or computer-readable data structure comprising code, instructions, metadata, and/or program state information generated or consumed by a compiler, decompiler, interpreter, emulator, and/or virtual machine to represent a program at an abstraction level between source code and machine code. Intermediate representations include, but are not limited to, VEX, LLVM Intermediate Representation (LLVM IR), Java bytecode, Multi-Level Intermediate Representation (MLIR), ESIL, Binary Analysis Platform (BAP) Intermediate Language (BIL), etc.

Vulnerability Database Data—A type of software file and/or computer-readable data comprising structured and/or unstructured information describing known, suspected, and/or classified software vulnerabilities. Such data may include, but is not limited to, historical and/or current vulnerability records (e.g., entries from the National Vulnerability Database (NVD), Common Vulnerabilities and Exposures (CVE), etc.), vulnerability taxonomies and/or classifications (e.g., Common Weakness Enumeration (CWE), etc.), exploitability and/or threat intelligence indicators (e.g., Known Exploited Vulnerabilities (KEV), etc.), severity metrics, remediation guidance, metadata, correlations among vulnerabilities, etc.

Compressed File—A type of software file whose size has been reduced using one or more compression algorithms and/or that encapsulates one or more internal files, directories, and/or data objects in a compressed and/or archived form. Compressed file formats include, but are not limited to, .zip, .rar, .tar, .gz, .xz, .7z, file system exports, etc.

Configuration File-A type of software file and/or computer-readable data comprising configuration parameters, settings, and/or directives that enable one or more users, systems, and/or processes to influence, control, and/or modify the behavior, operation, and/or execution of a computer program, service, and/or computing system. Configuration files may be provided in static and/or dynamic form and/or may be accessed at runtime, build time, and/or deployment time. Configuration files include, but are not limited to, .cfg, .ini, .json, .yaml, .yml, .xml, .env, .txt, environment variables, command-line arguments, configuration values provided through a user interface, configuration values supplied via an application programming interface (API), etc.

Build Artifact—A type of software file and/or computer-readable data generated as a result of a build, compilation, packaging, and/or deployment process. Build artifacts include, but are not limited to binary files, container images, virtual machine images, packages, archives, installers, debug symbols, logs, test results, intermediate representations, dependency manifests, metadata, and/or other outputs generated by build systems, compilers, linkers, package managers, and/or CI/CD pipelines.

Software File Data Source—An origin, repository, interface, and/or location from which one or more software files may be obtained, retrieved, and/or ingested by an AI-based cybersecurity vulnerability remediation system. Software file data sources may be local, remote, distributed, and/or cloud-based, and/or may support automated, scheduled, and/or on-demand access. Software file data sources include, but are not limited to, version control systems, local file systems, network file systems, object storage services, artifact repositories, container registries, persistent storage mechanisms, continuous integration and/or continuous delivery (CI/CD) pipelines, build systems, package managers, backup systems, any combinations thereof, etc.

Version Control System—A software system configured to track, manage, and/or store changes to software files, metadata, and/or revision histories over time, including support for branching, merging, access control, and/or collaboration. Version control systems may be centralized and/or distributed. Version control systems include, but are not limited to, Git, GitHub, GitLab, Bitbucket, Subversion (SVN), Perforce, Mercurial, etc.

Local File System—A software system, typically managed by an operating system, that organizes, stores, manages, and/or retrieves files on one or more local storage devices. Local file systems include, but are not limited to, NTFS, ext4, FAT32, APFS, XFS, etc.

Network File System—A software system, service, or protocol that enables access to software files and/or directories over a network, including local area networks, wide area networks, and/or the internet. Network file systems may support shared access, distributed storage, and/or cloud-based file hosting. Network file systems include, but are not limited to, Network File System (NFS), Server Message Block (SMB), Amazon S3, Google Cloud Storage, Azure Blob Storage, WebDAV, etc.

Persistent Storage Mechanism—A mechanism for durably storing one or more software files, software issues, event settings, notification settings, analysis messages, vulnerability data remediation artifacts, metadata, analysis results, and/or other data relevant to a generative AI-based cybersecurity vulnerability remediation system such that the stored data may be accessed, queried, and/or modified later. Persistent storage mechanisms may be local and/or remote and/or may be structured and/or unstructured. Persistent storage mechanisms include, but are not limited to, relational databases (e.g., PostgreSQL, MySQL, etc.), non-relational databases (e.g., MongoDB, Cassandra, etc.), file systems, object storage systems, key-value stores, data warehouses, vector databases, any combinations thereof, etc.

Software Ingestion or just “Ingestion”—A process by which one or more software files are obtained from one or more software file data sources and loaded into an AI-based cybersecurity vulnerability remediation system for further processing. Ingestion may include validation, normalization, transformation, metadata extraction, and/or indexing, and typically results in the software files being stored in analysis file storage prior to, during, and/or in preparation for agentic analysis.

Analysis File Storage—A software component, service, and/or persistent storage mechanism configured to store software files and/or associated data before, during, and/or after agentic analysis. Analysis file storage may support querying, reading, writing, updating, versioning, and/or deletion of stored software files zero, one, or multiple times during agentic analysis by an analysis agent ensemble and/or a user. Software files stored in analysis file storage may be automatically and/or manually removed based on one or more conditions, including but not limited to expiration policies, time thresholds, storage capacity thresholds, memory constraints, user input, and/or instructions generated by an analysis agent ensemble and/or an LLM interface. Software files may be flagged, labeled, and/or otherwise designated for extended and/or persistent retention in response to user input and/or automated decisions generated by an analysis agent ensemble.

Software Vulnerabilities and/or Software Issues and/or just “Vulnerabilities” and/or just “Issues”—Cybersecurity vulnerabilities, exploit conditions, misconfigurations, defects, weaknesses, and/or software quality problems that are identified, detected, inferred, classified, and/or reported by an analysis agent ensemble during and/or after analysis of one or more software files. Software vulnerabilities and/or issues include, but are not limited to: memory safety errors, such as stack-based buffer overflows, heap-based buffer overflows, use-after-free conditions, double frees, out-of-bounds reads or writes, null pointer dereferences, etc. ; injection vulnerabilities, such as SQL injection, command injection, code injection, cross-site scripting (XSS), etc.; authentication and/or authorization flaws, such as improper access control, privilege escalation, broken authentication, insecure session management, etc.; cryptographic weaknesses, such as use of weak and/or deprecated algorithms, improper key management, hard-coded secrets, insufficient entropy, insecure randomness, etc.; input validation and/or data handling issues, including improper sanitization, unsafe deserialization, unchecked user input, etc.; concurrency and/or logic errors, such as race conditions, deadlocks, time-of-check to time-of-use (TOCTOU) issues, flawed control flow, etc.; dependency and/or supply-chain issues, including vulnerable third-party libraries, outdated dependencies, license incompatibilities, unverified artifacts, etc.; configuration and/or deployment issues, such as insecure default settings, exposed credentials, excessive permissions, misconfigured services, etc.; code quality and/or maintainability issues, including dead code, unreachable code, duplicated logic, excessive complexity, poor error handling, resource leaks, performance bottlenecks, violations of coding standards and/or best practices, etc. Software vulnerabilities and/or issues may be stored via zero or more persistent storage mechanisms during and/or after agentic analysis. Software vulnerabilities and/or issues may be comprised of data fields including but not limited to text generated by one or more LLM interfaces, descriptions, titles, summaries, code snippets, patched code, remediation and/or mitigation advice, severity levels (e.g., major, moderate, minor, etc.), hyperlinks and/or other references to associated software files and/or software file data sources, related CVEs and/or CWEs, etc.

Large Language Model (LLM) Interface—A system, mechanism, service, and/or software component configured to communicate with, invoke, and/or interact with one or more large language models to generate, analyze, transform, and/or interpret data. An LLM interface may provide abstraction, orchestration, security, rate limiting, prompt management, response handling, and/or model selection, and/or may integrate with one or more local, remote, on-premises, and/or cloud-hosted LLM providers. LLM providers and/or models include, but are not limited to, models offered by OpenAI (e.g., ChatGPT, etc.), Anthropic (e.g., Claude, etc.), Google (e.g., Gemini, etc.), DeepSeek, open-source and/or self-hosted language models, and/or other generative and/or foundation model implementations.

Notification—Computer-readable data transmitted, published, and/or delivered to one or more notification data sinks, typically, though not exclusively, in response to one or more software issues identified and/or reported by an analysis agent ensemble during and/or after agentic analysis. A notification may convey raw, summarized, and/or enriched information relating to detected vulnerabilities, remediation actions, analysis results, and/or system status. Notifications may undergo zero or more formatting, transformation, enrichment, pre-processing, and/or post-processing operations prior to delivery. Such operations may include, but are not limited to: conversion into one or more file or data formats (e.g., .pdf, .csv, .html, .json, .xml, .cve, etc.); integration of content generated by a rewriter, compiler, decompiler, and/or other software analysis tool, including original, modified, and/or remediated code snippets; inclusion of hyperlinks and/or references to external resources, such as web-based user interfaces, detailed issue reports, source code locations, and/or remediation artifacts; aggregation and/or summarization of vulnerability-related metrics, including vulnerability counts, severity scores, exploitability indicators, patch effectiveness metrics, risk scores, code complexity metrics, and/or confidence levels; integration of visual elements, such as charts, graphs, tables, dashboards, etc.; inclusion of natural language text generated by one or more LLM interfaces; formatting and/or structuring specific to a target notification data sink, including designation of recipients, titles, priorities, templates, and/or delivery metadata; etc.

Notification Data Sink—A destination, endpoint, interface, or system to which one or more notifications may be delivered, transmitted, published, and/or stored during and/or after agentic analysis. Notification data sinks include, but are not limited to, user interfaces (e.g., browser-based, desktop-based, mobile-based interfaces, etc.), project management systems, communication platforms, version control systems, local file systems, network file systems, application programming interfaces (APIs), web requests, integrated development environments (IDEs), logging systems, ticketing systems, dashboards, CI/CD systems, software build systems, any combinations thereof, etc.

Project Management System—A software system configured to plan, track, organize, and/or manage work items, tasks, issues, and/or workflows associated with one or more software projects. Project management systems include, but are not limited to, issue trackers, ticketing systems, agile and/or kanban boards, and/or platforms such as Jira, GitHub Issues, GitLab Issues, Azure DevOps, ServiceNow, Asana, Trello, etc.

Communication Platform—A software system and/or service configured to enable communication, messaging, collaboration, and/or information sharing among users and/or systems. Communication platforms include, but are not limited to, email systems, chat and/or messaging applications, collaboration platforms, notification services, and/or systems such as Slack, Microsoft Teams, Discord, Mattermost, SMS, messaging gateways, etc.

Web Request—A network-based request transmitted between computing systems using one or more web and/or internet protocols to exchange data, trigger actions, and/or deliver notifications. Web requests include, but are not limited to, HTTP and/or HTTPS requests, RESTful API calls, GraphQL requests, webhooks, remote procedure calls (RPCs), TCP, UDP, etc.

Integrated Development Environment (IDE)—A software application and/or platform configured to facilitate software development activities, including code authoring, editing, navigation, building, testing, debugging, and/or analysis. Integrated development environments include, but are not limited to, Visual Studio Code, IntelliJ IDEA, Eclipse, Visual Studio, Xcode, PyCharm, etc.

Notification Setting—A configurable option, policy, rule set, and/or parameter collection established by one or more users, LLM interfaces, and/or other systems that governs the generation, routing, and/or delivery of notifications. A notification setting may specify one or more notification data sinks to which notifications are to be sent, as well as any parameters required to integrate with such notification data sinks. Notification settings may further define one or more triggering conditions under which a notification is generated or delivered. Such conditions include, but are not limited to, thresholds or classifications associated with software issues (e.g., severity level, confidence score, exploitability, and/or issue type, etc.), characteristics of an input source and/or software file, analysis context, workflow state, timing constraints, user-defined preferences, and/or decisions, inferences, and/or recommendations generated by an LLM interface, etc. Notification settings may be created, modified, and/or managed through user interface interactions, web-based forms, network requests, APIs, configuration files, etc. Notification settings may be stored using zero or more persistent storage mechanisms.

Event Setting—A configurable option, policy, rule set, and/or parameter collection established by one or more users, LLM interfaces, and/or other systems that governs when software ingestion, agentic analysis, and/or subsequent processing is initiated. An event setting may define one or more triggering events, conditions, and/or schedules that cause the AI-based cybersecurity remediation system to perform ingestion, analysis, and/or remediation actions. An event setting may further specify one or more target software file data sources, including identifiers such as a network location, uniform resource locator (URL), repository reference, branch name, tag, commit identifier, etc. Event settings may identify the types of events to which the system should respond, including but not limited to source code commits, pull requests, merges, pushes, releases, build completions, scheduled executions, manual invocations, etc. An event setting may define parameters controlling subsequent analysis or remediation, including but not limited to selection of an analysis agent ensemble, system prompts, initial user prompts, analysis scope, confidence thresholds, remediation policies, execution constraints, etc. Event settings may be created, modified, and/or managed through user interface interactions, web-based forms, network requests, APIs, configuration files, etc. Event settings may be stored using zero or more persistent storage mechanisms.

Software Analysis Tool and/or just “Tool”—A software component, mechanism, service, function, and/or executable program that may be invoked by an LLM interface, an analysis agent ensemble, and/or a user to perform one or more software analysis operations. A software analysis tool may perform security-focused analysis by directly producing security-related information, including but not limited to identified software vulnerabilities, weaknesses, risk indicators, etc., and/or may indirectly support security analysis by producing intermediate and/or contextual information useful in discovering, inferring, and/or validating software flaws, including but not limited to reading, parsing, navigating, and/or transforming software files, etc. Software analysis tools may be invoked with zero or more parameters supplied by an LLM interface, an analysis agent ensemble, and/or a user, including but not limited to identification of one or more target files, analysis scope, timeout values, search criteria, vulnerability categories, execution constraints, configuration options, etc. The output generated by software analysis tools may be transient and/or persistently stored, including storage within a message history (e.g., as tool invocation messages and/or tool response messages, etc.) and/or within one or more persistent storage mechanisms for subsequent analysis, reasoning, auditing, and/or remediation.

Static Application Security Testing (SAST)—A sub-classification of software analysis tools configured to analyze software files without executing the software. SAST analysis may include pattern matching, rule-based analysis, symbolic execution, control-flow analysis, data-flow analysis, taint analysis, linting, any combinations thereof, etc.

Dynamic Application Security Testing (DAST)—A sub-classification of software analysis tools configured to analyze software during execution and/or runtime. DAST analysis may include automated testing, fuzzing, fault injection, input mutation, runtime instrumentation, monitoring of execution traces, any combinations thereof, etc.

Software Composition Analysis (SCA) and/or Software Bill of Materials (SBOM) Generation—A sub-classification of software analysis tools configured to generate, extract, and/or analyze an inventory of software components, dependencies, libraries, modules, and/or associated metadata that comprise a software file. SCA and/or SBOM tools may identify component names, versions, licenses, cryptographic hashes, provenance information, and/or dependency relationships, and/or may be used to assess risk, compliance, and/or supply-chain security. SBOM formats include, but are not limited to, SPDX, CycloneDX, etc.

Analysis Message and/or just “Message”—Computer-readable content generated, exchanged, and/or recorded during agentic analysis by one or more components of an analysis agent ensemble. An analysis message may be generated by an LLM interface (e.g., an AI message), a user (e.g., a human message), a software analysis tool (e.g., a tool message), a system component (e.g., a system message), and/or another software component participating in the agentic analysis process. Analysis messages collectively form part of the operational context, state, and/or history of an analysis agent ensemble and may influence subsequent reasoning, decision-making, tool invocation, analysis flow, and/or remediation actions performed by the ensemble. Analysis message may be viewable by users via a user interface, API request, etc.

Analysis Message History or just “Message History”—A collection or ordered sequence of analysis messages associated with a particular agentic analysis, stored using one or more persistent storage mechanisms. The message history may be accessed, queried, and/or referenced by zero or more users, an LLM interface, an analysis agent ensemble, and/or another system component during agentic analysis to influence the behavior of an LLM interface and/or an ensemble, including by modifying the operational context and/or context window, supplying and/or updating system prompts and/or initial user prompts, guiding and/or constraining the selection and/or invocation of software analysis tools, directing analysis toward particular software files and/or directories, specifying categories and/or types of software issues and/or vulnerabilities to prioritize and/or exclude, etc.

System Prompt—A sub-classification of system messages provided to an LLM interface, typically included at and/or near the beginning of a message history, to establish operational constraints, behavioral guidance, objectives, and/or contextual information for agentic analysis. A system prompt may define how the LLM interface is to reason, what tasks it is to perform, what tools it may invoke, and what policies and/or limitations govern its operation. System prompts may include, but are not limited to, instructions defining analysis goals, security policies, remediation objectives, reasoning strategies, tool usage constraints, output formats, prioritization rules, confidence thresholds, compliance requirements, and/or other guidance intended to influence or control the behavior of the LLM interface and/or associated analysis agent ensemble.

Initial User Prompt—A sub-classification of human messages provided to an LLM interface, typically included at or near the beginning of a message history and/or incorporated within a system prompt. An initial user prompt is generally the first message supplied by a user in connection with an agentic analysis and/or may be recorded prior to the commencement of agentic analysis, for example in accordance with an event setting, a preliminary user input, and/or a predefined workflow. The initial user prompt typically conveys user intent, preferences, and/or objectives regarding how the analysis is to be performed, including desired goals for the LLM interface, analysis scope, prioritization criteria, remediation expectations, and/or other instructions intended to influence the behavior of the analysis agent ensemble.

Retrieval Augmented Generation (RAG)—A technique in which an LLM interface generates output conditioned not only on prompt data and/or message history, but also on additional context retrieved from one or more external data sources. In a RAG process, relevant information is identified, retrieved, and/or incorporated into the input provided to the LLM interface to improve accuracy, relevance, completeness, and/or grounding of generated outputs. Within an AI-based cybersecurity vulnerability remediation system, RAG may be used to retrieve software files, code chunks and/or fragments, configuration data, vulnerability database data, prior analysis results, remediation artifacts, documentation, policies, and/or other contextual information to inform agentic analysis, vulnerability detection, classification, explanation, and/or remediation. RAG may be invoked by an LLM interface, via an analysis agent ensemble, and/or in the context of one or more software analysis tools.

### 1) Component(s) of Generative AI-Based Cybersecurity Vulnerability Remediation System Architecture

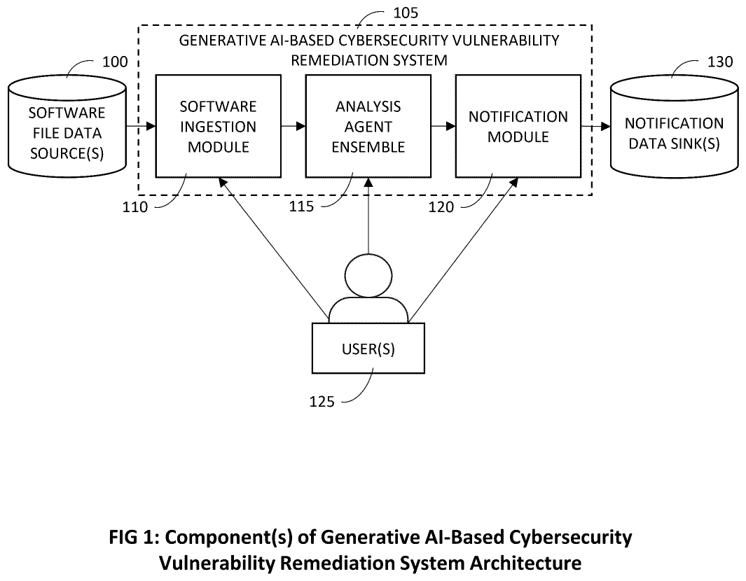

FIG. 1 depicts an exemplary system architecture of a Generative AI-based Cybersecurity Vulnerability Remediation System 105. The system may take as input zero or more software files from one or more Software File Data Source(s) 100. The system may deliver zero or more notifications to zero or more Notification Data Sink(s). The behavior and/or operation of the system may be configured, initiated, and/or influenced by one or more User(s) 125.

The number, type, arrangement, and order of components shown in FIG. 1 are merely illustrative. Components may be substituted, combined, omitted, rearranged, and/or supplemented in any manner without departing from the scope of the invention.

### 1.1) Software Ingestion

The system may include a Software Ingestion Module 110 configured to perform software ingestion from one or more Software File Data Source(s) 100. Ingested software files may be stored in analysis file storage and/or provided for subsequent processing, including but not limited to agentic analysis.

One or more User(s) 125 may interact with a Software Ingestion Module 110 to define, modify, and/or manage event settings. In some embodiments, user input may be combined with automated decisions generated by an analysis agent ensemble, an LLM interface, and/or other software component(s) to control software ingestion, etc..

### 1.2) Agentic Analysis

The system may include one or more Analysis Agent Ensembles 115 configured to analyze one or more ingested software files in order to identify, detect, infer, and/or report zero or more software issues. Agentic analysis may be performed in a single pass or across multiple passes. During agentic analysis, an Analysis Agent Ensemble 115 may access, query, and/or interact with analysis file storage and/or the ingested software files one or more times, including through direct file access, database queries, invocation of software analysis tools, etc.

Agentic analysis may incorporate input from zero or more User(s) 125. User input may include, but is not limited to, defining and/or modifying system prompts or initial user prompts, selecting and/or overriding a particular analysis agent ensemble implementation, providing additional user messages for inclusion in message history, uploading additional software files and/or directories, selecting and/or configuring software analysis tools and/or their associated parameters, specifying an LLM interface to use, configuring termination conditions (e.g., time, memory, and/or storage constraints), prioritizing and/or deprioritizing portions of the software under analysis, etc. In some embodiments, user input may be combined with automated decisions generated by an analysis agent ensemble, an LLM interface, or another software component to control agentic analysis.

### 1.3) Notifications

Zero or more identified software issues may be processed, enriched, and/or formatted by a Notification Module 120 and/or delivered to one or more Notification Data Sink(s) 130.

One or more User(s) 125 may interact with a Notification Module 130 to define, modify, and/or manage notification settings, etc. In some embodiments, user input may be combined with automated decisions generated by an analysis agent ensemble, an LLM interface, or another software component to control notifications.

### 2) Functional Diagram for Software Ingestion Module

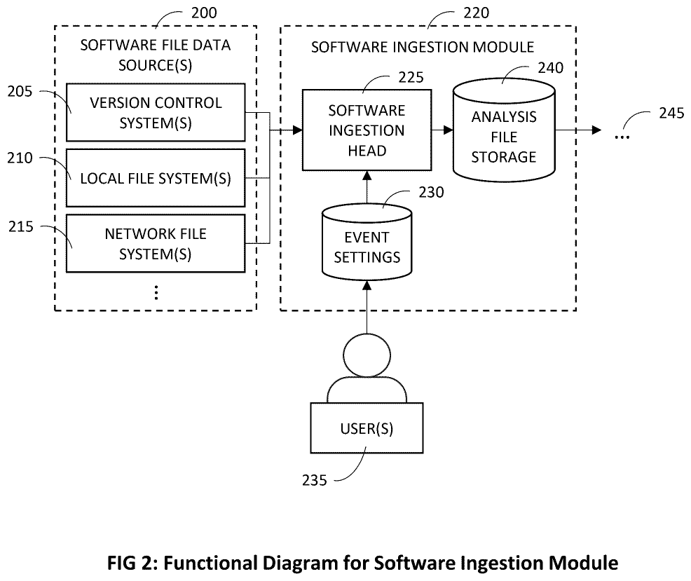

FIG. 2 depicts an exemplary functional diagram illustrating how one or more software files may be ingested into a generative AI-based cybersecurity vulnerability remediation system from one or more Software File Data Sources 200 by a Software Ingestion Module 220, prior to and/or during agentic analysis. The behavior and/or operation of a Software Ingestion Module 220 may be configured, initiated, and/or influenced by one or more User(s) 125.

FIG. 2 may be considered an example of Software File Data Source(s) 100 and/or a Software Ingestion Module 110.

The number, type, arrangement, and order of components shown in FIG. 2 are merely illustrative. Components may be substituted, combined, omitted, rearranged, and/or supplemented in any manner without departing from the scope of the invention.

### 2.1) Software File Data Source(s)

Software File Data Source(s) 200 may include but are not limited to Version Control System(s) 205, Local File System(s) 210, and/or Network File System(s) 215. Each software file data source may store and/or provide access to software files in one or more formats, including, but not limited to, binary files, source code files, and/or intermediate representations, etc.

### 2.2) Software Ingestion Module

A Software Ingestion Module 220 may include a Software Ingestion Head 225 configured to determine when software ingestion occurs and/or which software files are ingested from one or more Software File Data Source(s) 200. Software ingestion may be initiated periodically, manually, automatically, and/or in response to one or more conditions and/or events, etc. Ingestion may target an entire software project, a subset of a project, multiple projects, one or more individual files, portions of a firmware image, specific binaries and/or shared objects, and/or entire file systems, etc.

Software ingestion may further include zero or more pre-processing operations, including, but not limited to, filtering files deemed irrelevant for subsequent agentic analysis (e.g., based on file size, file type, and/or other criteria), modifying directory structures, renaming files, and/or removing, adding, and/or modifying file contents, etc.

One or more User(s) 235 may define, modify, and/or manage one or more Event Settings 230 that control operation of the Software Ingestion Head 225 and/or govern when and/or how software ingestion is performed.

Ingested software files may be stored in Analysis File Storage 240 and/or otherwise made accessible for Subsequent Agentic Analysis 245 and/or another subsequent processing step and/or software component, etc.

### 3) Functional Diagram for File Navigation-Based Analysis Agent Ensemble

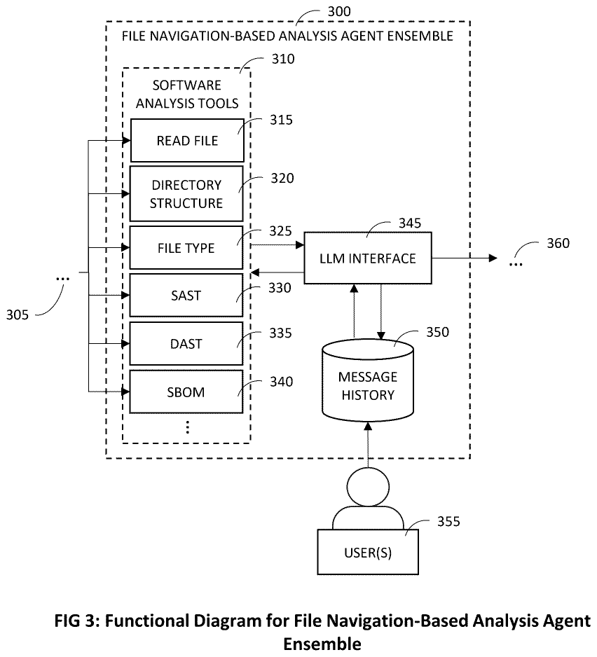

FIG. 3 depicts an exemplary functional diagram illustrating how a File Navigation-Based Analysis Agent Ensemble 300 may analyze one or more Ingested Software Files 305 through invocation of one or more Software Analysis Tools 310 to identify, detect, infer, and/or report zero or more Software Issues 360. The behavior and operation of the File Navigation-Based Analysis Agent Ensemble 300 may be configured, initiated, and/or influenced by one or more User(s) 355.

FIG. 3 may be considered an example of an Analysis Agent Ensemble 115.

The number, type, arrangement, and order of components shown in FIG. 3 are merely illustrative. Components may be substituted, combined, omitted, rearranged, and/or supplemented in any manner without departing from the scope of the invention. 3.1) Tool Usage

In a File Navigation-Based Analysis Agent Ensemble 300, an LLM Interface 345 may invoke zero or more Software Analysis Tools 310 to analyze Ingested Software Files 305, which may be stored in analysis file storage. Software Analysis Tools 310 may be used to inspect, navigate, classify, and/or analyze software files and/or directories in support of agentic analysis, etc.

Software Analysis Tools 310 may include, but are not limited to:
a Read File Tool 315, configured to read, extract, display, and/or otherwise observe the contents of a software file, in whole or in part;
a Directory Structure Tool 320, configured to read, traverse, display, and/or otherwise observe the structure of one or more directories, including nested subdirectories containing software files;
a File Type Tool 325, configured to determine, inspect, and/or report the type and/or format of one or more software files, including file extensions, MIME types, magic numbers, and/or other identifying characteristics;
SAST 330, DAST 335, and/or SCA/SBOM 340 tools, configured to analyze software files, dependencies, and/or runtime behavior to identify, detect, and/or report software issues or vulnerabilities; and/or,
other software analysis tools not expressly described herein that support software file and/or directory navigation, vulnerability discovery, issue classification, and/or related analysis functions in support of a File Navigation-Based Analysis Agent Ensemble 300.

### 3.2) User Interaction

Zero or more User(s) 355 may influence and/or control the behavior of a File Navigation-Based Analysis Agent Ensemble 300, for example by interacting with a Message History 350 and/or other software component(s) within the ensemble.

### 3.3) Reporting Software Issues

In a File Navigation-Based Analysis Agent Ensemble 300, an LLM Interface 345 may identify, detect, infer, classify, and/or report zero or more Software Issues 360 based on analysis of Ingested Software Files 305, outputs generated by one or more Software Analysis Tools 310, input from one or more User(s) 355, or any combination thereof. Reported Software Issues 360 may be forwarded, transmitted, and/or otherwise provided to a notification module, a remediation component, and/or one or more other constituent software components of the generative AI-based cybersecurity vulnerability remediation system for further processing, reporting, remediation, etc.

### 4) Functional Diagram for RAG-Based Analysis Agent Ensemble

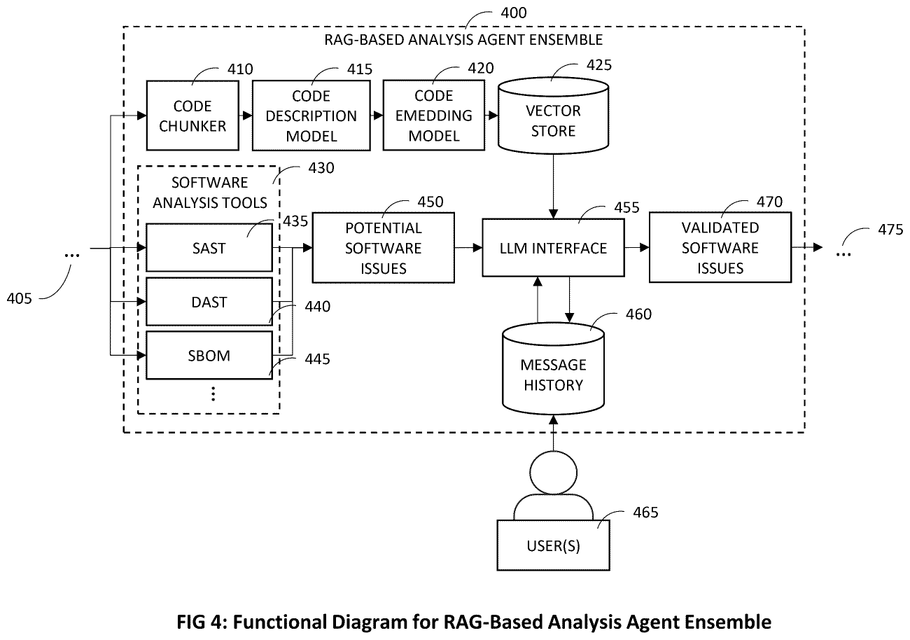

FIG. 4 depicts an exemplary functional diagram illustrating how a RAG-Based Analysis Agent Ensemble 400 may analyze one or more Ingested Software Files 405 through a combination of a RAG pipeline and an automated software analysis tool pass to identify, detect, infer, and/or report zero or more Software Issues 475. The behavior and/or operation of the RAG-Based Analysis Agent Ensemble 400 may be configured, initiated, and/or influenced by one or more User(s) 465.

FIG. 4 may be considered an example of an Analysis Agent Ensemble 115.

The number, type, arrangement, and order of components shown in FIG. 4 are merely illustrative. Components may be substituted, combined, omitted, rearranged, and/or supplemented in any manner without departing from the scope of the invention.

### 4.1) RAG Pipeline

In a RAG-Based Analysis Agent Ensemble 400, a RAG pipeline may be employed to enable an LLM Interface 455, one or more User(s) 465, one or more Software Analysis Tools 430, and/or another software component to pre-process, describe, embed, index, and/or store software files and/or portions thereof in a vector store for use during and/or after agentic analysis.

A RAG pipeline may include one or more data processing steps and/or software components, including but not limited to:
a Code Chunker 410, configured to divide Ingested Software Files 405 into smaller units and/or chunks arbitrarily and/or based upon certain criteria such as by class, function, method, basic block, and/or other logical and/or structural boundaries, depending on the software file type, programming language, binary architecture, etc.;
a Code Description Model 415, configured to generate one or more descriptions, annotations, and/or metadata representations for some or all code chunks, for example using an AI/ML model, an LLM interface, an algorithmic technique, etc.;
a Code Embedding Model 420, configured to transform some or all code chunks and/or associated descriptions into fixed-length vector representations, wherein similarity between vectors, as measured by one or more distance or similarity metrics (e.g., cosine similarity, Euclidean distance, etc.), corresponds to semantic similarity; and/or,
a Vector Store 425, configured to store, index, and/or retrieve embedded code chunks and/or associated descriptions using one or more persistent storage mechanisms. A Vector Store 425 may support similarity-based queries by an LLM Interface 455, one or more User(s) 465, one or more Software Analysis Tool(s) 430, and/or another software component to identify code chunks and/or descriptions having semantic relevance to a query input.

In other embodiments, RAG may be implemented using alternative data sources, processing steps, and/or component arrangements. For example, RAG may be used to retrieve external documentation, internet-based data, vulnerability database data, and/or prior analysis results, and/or may include different and/or additional processing components, such as multiple description models, alternative embedding strategies, omission of code chunking, alternative similarity search mechanisms, and/or other variations, etc.

### 4.2) Automated Software Analysis Tool Pass

In a RAG-Based Analysis Agent Ensemble 400, an automated software analysis tool pass may be performed on one or more Ingested Software Files 405 using one or more Software Analysis Tools 430. Software Analysis Tools 430 may include, but are not limited to, SAST 435, DAST 440, SCA/SBOM 445 tools, and/or other software analysis tools configured to analyze software files, dependencies, configuration data, and/or runtime behavior to identify, detect, and/or report software issues and/or vulnerabilities, etc.

An automated software analysis tool pass may produce zero or more Potential Software Issues 450. Potential Software Issues 450 may represent preliminary findings that have not yet been validated or invalidated and/or may include false positives, incomplete descriptions, low-impact findings, duplicate reports, and/or otherwise ambiguous results, etc.

Zero or more Potential Software Issues 450 may be provided to an LLM Interface 455 for further analysis. An LLM Interface 455 may, for some or all Potential Software Issues 450, query a Vector Store 425—for example, by retrieving code chunks and/or descriptions having semantic similarity to the reported issue and/or by identifying related code regions that may influence the behavior of the issue—and/or perform one or more additional filtering, correlation, and/or reasoning steps to validate or invalidate each issue. The resulting set of issues may comprise zero or more Validated Software Issues 470.

In other embodiments, Software Analysis Tools 430 may not be invoked automatically and/or instead may be selectively invoked by an LLM Interface 455, one or more User(s) 465, and/or another software component. In further embodiments, validation or invalidation of Potential Software Issues 450 may be performed without querying a vector store, for example using alternative reasoning techniques, rule-based logic, additional tool invocations, and/or user input, etc.

### 4.3) User Interaction

Zero or more User(s) 465 may influence and/or control the behavior of a RAG-Based Analysis Agent Ensemble 400 by interacting with a Message History 460 and/or other software component(s) within the ensemble.

### 4.4) Reporting Software Issues

Zero or more Validated Software Issues 470 may be forwarded, transmitted, and/or otherwise provided as Software Issues 475 to a notification module, a remediation component, and/or zero or more other constituent software components of the generative AI-based cybersecurity vulnerability remediation system for further processing, reporting, and/or remediation, etc.

### 5) Functional Diagram for Function Vulnerability Scanning Analysis Agent Ensemble

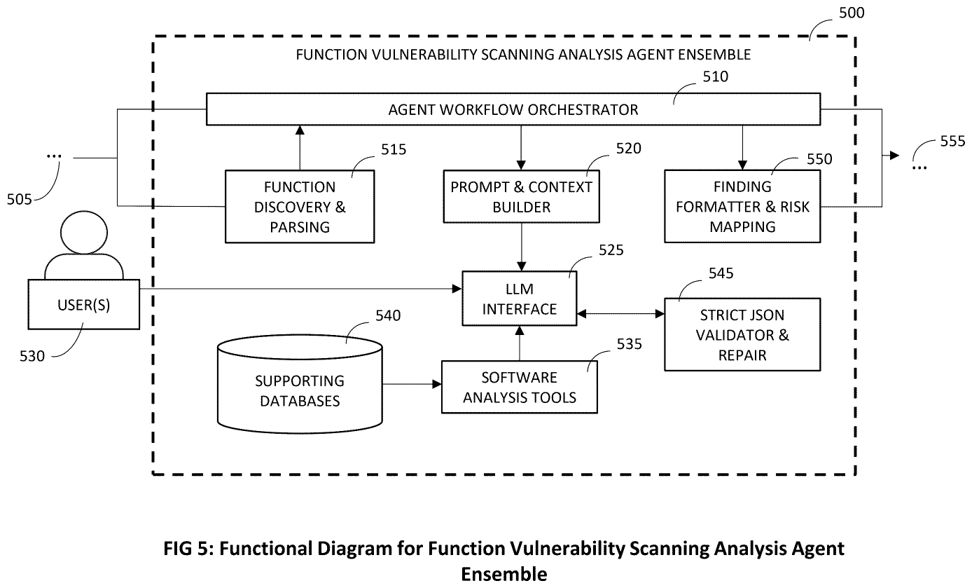

FIG. 5 depicts an exemplary functional diagram illustrating how a Function Vulnerability Scanning Analysis Agent Ensemble 500 may analyze one or more Ingested Software Files 505 by identifying, characterizing, and/or reporting zero or more Software Issues 555 associated with one or more software functions. The behavior and/or operation of the Function Vulnerability Scanning Analysis Agent Ensemble 500 may be configured, initiated, and/or influenced by one or more User(s) 530, etc.

FIG. 5 may be considered an example of an Analysis Agent Ensemble 115.

The number, type, arrangement, and order of components shown in FIG. 5 are merely illustrative. Components may be substituted, combined, omitted, rearranged, and/or supplemented in any manner without departing from the scope of the invention.

### 5.1) Software File Intake & Function Analysis

A Function Vulnerability Scanning Analysis Agent Ensemble 500 may comprise one or more software components configured to receive, acquire, extract, identify, enumerate, parse, and/or normalize Ingested Software Files 505 for analysis at a function-level granularity. These components may include, but are not limited to, an Agent Workflow Orchestrator 510 configured to orchestrate and/or coordinate scanning workflows, and/or Function Discovery & Parsing 515 configured to identify and/or analyze individual functions and/or functional units, etc.

Function Discovery & Parsing 515 may include, but is not limited to, determining function boundaries, control-flow structures, data-flow relationships, inter-procedural relationships (e.g., callers and/or callees), dependencies on libraries, modules, packages, headers, and/or imported symbols, and/or metadata associated with build systems and/or deployment environments, etc.

A Function Vulnerability Scanning Analysis Agent Ensemble 500 may further interact with one or more Supporting Databases 540, including, but not limited to, code repositories, artifact stores, symbol databases, call graph databases, version control systems, and/or prior scan results. In an example, extracted functions and/or associated metadata may be normalized into one or more canonical representations suitable for downstream analysis, prompting, tool invocation, and/or storage, etc.

### 5.2) AI-Driven Vulnerability Reasoning & Tool Augmentation

A Function Vulnerability Scanning Analysis Agent Ensemble 500 may further comprise one or more components configured to perform automated and/or semi-automated vulnerability reasoning using artificial intelligence techniques. These components may include, but are not limited to, a Prompt & Context Builder 520, an LLM Interface 525, and/or one or more Software Analysis Tools 535, etc.

A Prompt & Context Builder 520 may be configured to assemble, curate, transform, compress, and/or structure analysis context for vulnerability reasoning. Context construction may include, but is not limited to, selecting relevant function excerpts, summarizing and/or chunking code, incorporating call graph neighborhoods, data-flow highlights, historical scan results retrieved from Supporting Databases 540, security policies, coding standards, secure development guidelines, and/or constraints intended to increase determinism and/or reduce hallucinations, etc.

An LLM Interface 525 may handle request formatting, authentication, rate limiting, model selection, context window management, response streaming, and/or output post-processing. AI-driven reasoning may include, but is not limited to, vulnerability identification, classification, explanation, prioritization, critique, and/or iterative refinement, etc.

Outputs generated by Software Analysis Tools 535 may be incorporated into subsequent AI reasoning cycles.

### 5.3) Output Validation, Normalization & Risk Mapping

A Function Vulnerability Scanning Analysis Agent Ensemble 500 may further comprise one or more components configured to enforce structural constraints, validate outputs, repair malformed data, normalize findings, and/or map identified issues to standardized and/or internal risk representations, etc. These components may include, but are not limited to, a Strict JSON Validator & Repair 545 component and/or a Finding Formatter & Risk Mapping 550 component.

A Strict JSON Validator & Repair 545 component may be configured to enforce schema compliance, required fields, allowed enumerations, type constraints, and/or deterministic formatting rules on outputs generated by an LLM Interface 525 and/or Software Analysis Tools 535, etc. Validation and/or repair operations may include, but are not limited to, detecting schema violations, re-prompting AI systems, constrained decoding, field inference under predefined rules, reformatting outputs, removing extraneous tokens, replacing invalid enumerations, and/or inserting missing required fields, etc.

A Finding Formatter & Risk Mapping 550 component may be configured to transform validated outputs into normalized Software Issues 555. Resulting normalized Software Issues 555 may be stored in Supporting Databases 540 and/or prepared for subsequent reporting, remediation, and/or notification workflows, etc.

### 5.4) User Interaction, Reporting & Feedback

A Function Vulnerability Scanning Analysis Agent Ensemble 500 may further comprise one or more interfaces and/or mechanisms through which one more User(s) 530 may interact with an LLM Interface 525 and/or its outputs.

User(s) 530 may initiate scans, configure analysis parameters, review findings produced by a Finding Formatter & Risk Mapping 550 component, approve and/or reject identified vulnerabilities, prioritize remediation actions, and/or provide feedback. Feedback captured from User(s) 530 and/or downstream systems may be stored in Supporting Databases 540 and/or used to refine future vulnerability scanning, reasoning, validation, and/or risk mapping operations over time.

### 6) Functional Diagram for LLM Tool Usage in Agentic Analysis

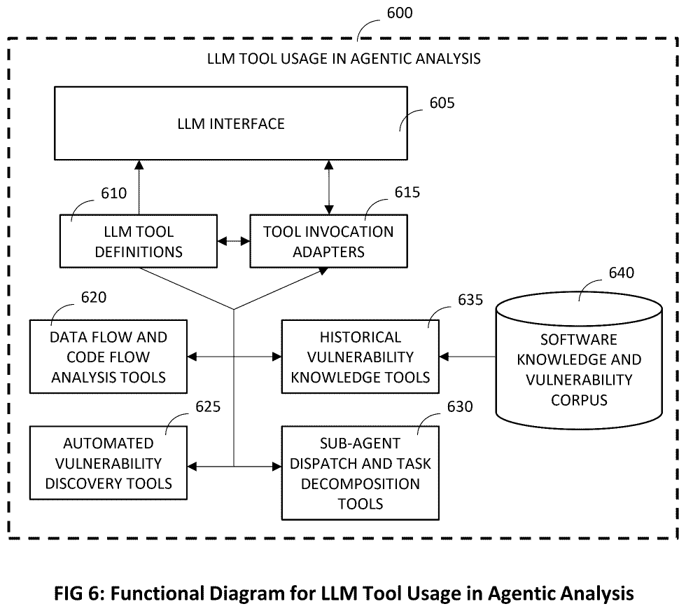

FIG. 6 depicts an exemplary functional diagram for LLM Tool Usage in Agentic Analysis 600, illustrating how one or more LLM Interfaces 605 may be augmented with and/or use software analysis tools in the context of an analysis agent ensemble.

The number, type, arrangement, and order of components shown in FIG. 6 are merely illustrative. Components may be substituted, combined, omitted, rearranged, and/or supplemented in any manner without departing from the scope of the invention.

### 6.1) LLM-Based Program Analysis & Reasoning

An LLM Interface 605 may be configured to serve as a coordinating and/or execution layer that applies LLM-based analysis to software files and/or extracted information including but not limited to call graphs, control-flow graphs, data-flow representations, and/or other program metadata. An LLM Interface 605 may receive inputs from upstream systems, components, and/or users and/or may generate intermediate and/or final agentic analysis outputs.

An LLM Interface 605 may be configured to perform structured and/or unstructured reasoning over program analysis inputs. Reasoning may include, but is not limited to, identifying potential software issues, explaining program behavior, hypothesizing exploit paths, evaluating security properties, prioritizing risks, and/or iteratively refining conclusions. An LLM Interface 605 may operate in one or more modes, including, but not limited to, single-pass inference, multi-step reasoning, critique-and-revision, chain-of-thought reasoning, tool-augmented reasoning workflows, etc.

### 6.2) Software Analysis Tool Definition, Invocation, & Orchestration

LLM Tool Definitions 610 may describe available tools, their capabilities, required inputs, expected outputs, constraints, and/or invocation semantics in a format consumable by an LLM Interface 605. Tool definitions may include, but are not limited to, schemas, function signatures, natural language descriptions, examples, and/or policy constraints governing tool usage.

Tool Invocation Adapters 615 may be configured to translate LLM-generated tool invocation requests into executable tool calls. This may include, but is not limited to, input validation, parameter mapping, authentication, sandboxing, execution control, error handling, and/or output normalization. Tool Invocation Adapters 615 may translate tool outputs into representations suitable for consumption by an LLM Interface 605.

### 6.3) Software Analysis Tool Examples

An LLM Interface 605 may be augmented with and/or use several varieties of software analysis tools. These may include, but are not limited to:
Data Flow and Code Flow Analysis Tools 620, which may include, but are not limited to, software analysis tools configured to analyze control-flow graphs, data-flow paths, taint propagation, inter-procedural dependencies, and/or execution paths within software files;
Automated Vulnerability Discovery Tools 625, which may include, but are not limited to, SAST, DAST, SCA/SBOM, and/or other automated mechanisms for identifying software issues;
Sub-Agent Dispatch and Task Decomposition Tools 630, which may be configured to decompose complex analysis tasks into smaller subtasks and/or dispatch those subtasks to specialized sub-agents, tools, and/or analysis routines; and/or,
Historical Vulnerability Knowledge Tools 635 and/or a Software Knowledge and Vulnerability Corpus 640, which may include, but are not limited to, structured and/or unstructured data sources such as prior vulnerability reports, CVE records, exploit databases, code examples, remediation guidance, secure coding patterns, and/or historical analysis results. These knowledge sources may be queried and/or incorporated into LLM reasoning workflows to improve accuracy, consistency, contextual awareness, etc.

### 7) Functional Diagram for Code and Function Pre-Processing Module

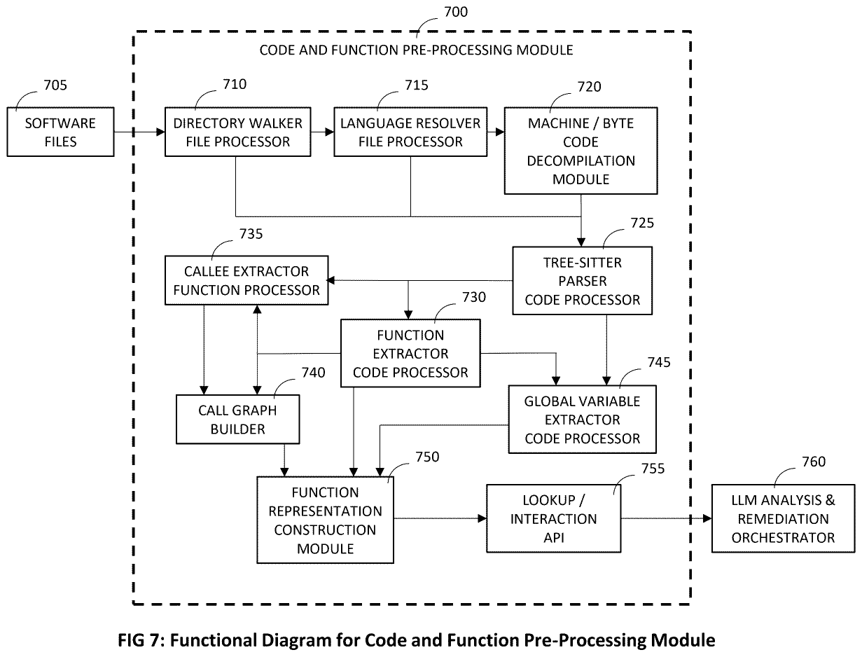

FIG. 7 depicts an exemplary functional diagram for a Code and Function Pre-Processing Module 700, illustrating how Software Files 705 may be ingested, traversed, analyzed, transformed, and/or prepared for downstream analysis, software issue detection, and/or remediation workflows in the context of an analysis agent ensemble.

The number, type, arrangement, and order of components shown in FIG. 7 are merely illustrative. Components may be substituted, combined, omitted, rearranged, and/or supplemented in any manner without departing from the scope of the invention.

### 7.1) Software File Intake, File Traversal, & Language Resolution

A Code and Function Pre-Processing Module 700 may comprise one or more software components configured to receive, access, traverse, classify, and/or organize Software Files 705 prior to deeper code and/or function analysis. These components may include, but are not limited to:
a Directory Walker File Processor 710, which may be configured to recursively traverse directory structures, enumerate files, apply inclusion and/or exclusion rules, detect file hierarchies, and/or generate inventories of discovered software files; and/or,
a Language Resolver File Processor 715, which may be configured to determine one or more programming languages, file formats, and/or runtime environments associated with each discovered file. Language resolution may include, but is not limited to, analysis of file extensions, shebangs, magic headers, content inspection, dependency manifests, build metadata, and/or heuristic and/or AI-based classifiers. Language resolution results may be used to route files to appropriate downstream processors.

### 7.2) Code Parsing, Decompilation, & Structural Extraction

A Code and Function Pre-Processing Module 700 may further comprise one or more components configured to transform software files into structured representations suitable for function-level analysis. These components may include, but are not limited to:
a Machine/Byte Code Decompilation Module 720, which may be configured to process compiled artifacts, bytecode, and/or other non-source representations, producing decompiled and/or lifted representations;
a Tree-Sitter Parser Code Processor 725, which may parse code into abstract syntax trees (ASTs) and/or other structural representations;
a Function Extractor Code Processor 730, which may identify and/or extract individual functions, methods, procedures, and/or callable units, including associated metadata such as parameters, return values, annotations, and/or visibility;
a Call Graph Builder 740, which may analyze inter-procedural relationships to construct call graphs representing caller-callee relationships within and/or across files, modules, and/or libraries; and/or,
a Global Variable Extractor Code Processor 745, which may identify global and/or shared state, including global variables, constants, static fields, and/or configuration parameters, and/or associate such state with relevant functions and/or call paths.

### 7.3) Function Representation Construction & Normalization

A Code and Function Pre-Processing Module 700 may further comprise one or more components configured to synthesize extracted code structures into normalized and/or canonical function representations. These components may include, but are not limited to, a Function Representation Construction Module 750, which may combine inputs from function extraction, call graph construction, global variable extraction, parsing, and/or decompilation to produce one or more structured representations of each function. Representations may include, but are not limited to, source-level views, intermediate representations, control-flow graphs, data-flow graphs, dependency graphs, and/or hybrid representations suitable for machine reasoning. In an example, representations may be enriched with contextual metadata including language, file location, dependency context, security-relevant annotations, and/or provenance information.

Normalized function representations may be stored, cached, indexed, and/or prepared for downstream consumption by analysis, vulnerability scanning, remediation, and/or explanation components.

### 7.4) Orchestration, Interaction, & Downstream Integration

A Code and Function Pre-Processing Module 700 may further comprise one or more components configured to coordinate preprocessing workflows, expose results to other components, and/or integrate with analysis and/or remediation pipelines in the context of an analysis agent ensemble. These components may include, but are not limited to:
a Lookup/Interaction API 755, which may provide programmatic access to pre-processed artifacts, extracted functions, call graphs, global variable data, and/or function representations. The API may support operations including, but not limited to, querying, filtering, retrieving, updating, and/or annotating preprocessing outputs; and/or,
an LLM Analysis & Remediation Orchestrator 760, which may be configured to consume normalized function representations and/or coordinate downstream AI-driven analysis and remediation workflows. This may include, but is not limited to, dispatching functions for vulnerability scanning, invoking LLM-based reasoning systems, correlating findings, triggering remediation actions, and/or managing feedback loops between preprocessing, analysis, and/or remediation stages.

### 8) Functional Diagram for Machine/Byte Code Decompilation Module

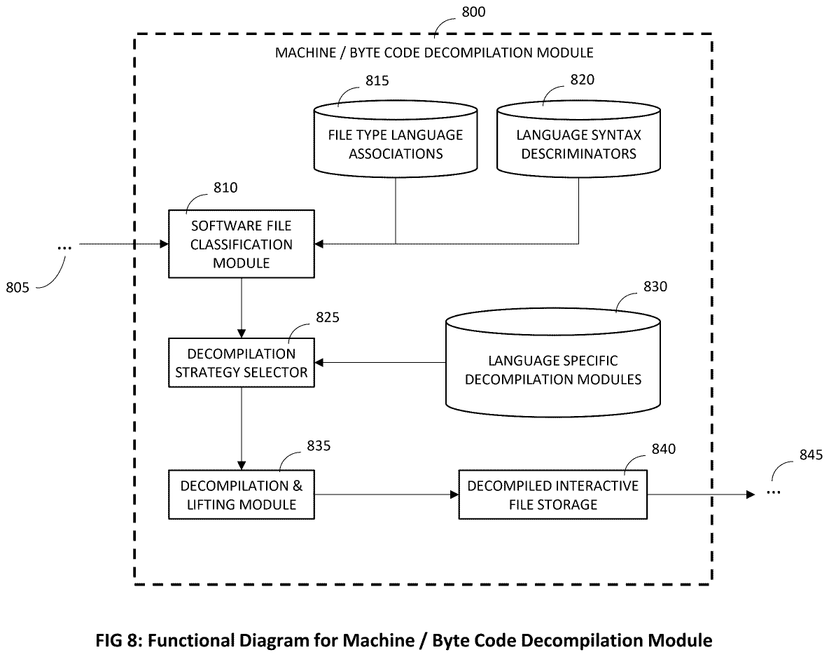

FIG. 8 depicts an exemplary functional diagram for a Machine/Byte Code Decompilation Module 800, illustrating how one or more Software Files 805 may be classified, analyzed, decompiled, lifted, transformed, and/or stored as interactive decompiled representations in the context of an analysis agent ensemble.

FIG. 8 may be considered an example of a Machine/Byte Code Decompilation Module 720

The number, type, arrangement, and order of components shown in FIG. 8 are merely illustrative. Components may be substituted, combined, omitted, rearranged, and/or supplemented in any manner without departing from the scope of the invention.

### 8.1) Software File Intake, Classification, & Language Identification

A Machine/Byte Code Decompilation Module 800 may comprise one or more software components configured to receive and/or ingest one or more Software Files 805 and/or determine properties relevant to decompilation and/or lifting. These components may include, but are not limited to, a Software File Classification Module 810 configured to identify one or more characteristics of an input software file.

A Software File Classification Module 810 may determine attributes including, but not limited to, whether a software file is a native binary, bytecode, intermediate representation, library, firmware image, container image, executable, object file, archive, script, and/or other data format. Classification may include, but is not limited to, identification of instruction set architecture (ISA), operating system and/or ABI characteristics, endianness, compiler signatures, symbol availability, debug information availability, packing and/or obfuscation indicators, and/or encryption and/or compression characteristics.

An Software File Classification Module 810 may utilize File Type and Language Associations 815, which may comprise one or more mappings between file types, container formats, bytecode formats, executable formats, and/or other software file properties and candidate programming languages and/or runtime environments. These mappings may include, but are not limited to, associations for ELF, PE, Mach-O, JVM bytecode, .NET IL, WebAssembly, Python bytecode, and/or other executable and/or intermediate formats.

A Software File Classification Module 810 may further utilize Language Syntax Discriminators 820, which may comprise one or more heuristics, classifiers, rulesets, and/or AI-based models configured to infer a likely source-language and/or intermediate-language representation. Language Syntax Discriminators 820 may analyze features including, but not limited to, opcode distributions, instruction patterns, calling conventions, control-flow shapes, exception handling structures, metadata sections, symbol naming conventions, string tables, library import patterns, and/or other structural indicators.

### 8.2) Decompilation Strategy Selection

A Machine/Byte Code Decompilation Module 800 may further comprise one or more components configured to select an appropriate decompilation approach for at least one software file based on classification and/or language identification outputs. These components may include, but are not limited to a Decompilation Strategy Selector 825, which may select from multiple Language-Specific Decompilation Modules 830.

A Decompilation Strategy Selector 825 may consider factors including, but not limited to, software file type, architecture, available symbols, presence of debug metadata, packing and/or obfuscation indicators, performance constraints, accuracy targets, and/or user-provided constraints.

Language-Specific Decompilation Modules 830 may include separate modules for different targets, including, but not limited to, native code decompilers for one or more architectures, bytecode decompilers for managed runtimes, and/or lifting modules that convert low-level representations into higher-level intermediate representations. Language-Specific Decompilation Modules 830 may include customized parsing, control-flow recovery, data-flow recovery, type recovery, symbol recovery, structure recovery, and/or idiom recognition mechanisms aligned with a target language and/or compiler patterns. Language-Specific Decompilation Modules 830 may encompass multiple strategies, including, but not limited to, static decompilation, dynamic analysis-assisted decompilation, hybrid lifting-and-recovery approaches, partial and/or incremental decompilation, and/or multi-pass decompilation workflows.

### 8.3) Language-Specific Decompilation & Lifting

A Machine/Byte Code Decompilation Module 800 may further comprise a Decompilation & Lifting Module 835, which may transform and/or lift low-level instructions and/or bytecode into one or more intermediate representations and/or decompiled source-like representations using zero or more selected Language-Specific Decompilation Modules 830.

Lifting may include, but is not limited to, recovering control-flow graphs, generating abstract syntax trees, generating SSA-like forms, reconstructing higher-level constructs such as loops and conditionals, recovering function signatures, inferring variable types, and/or reconstructing class and/or object structures where applicable. The resulting decompiled output may be produced as text, structured representations, and/or interactive artifacts.

A Decompilation & Lifting Module 835 may coordinate selected strategies by sequencing steps, selecting toolchains and/or modules, managing intermediate representations, and/or applying post-processing transformations. In an example, a Decompilation & Lifting Module 835 may support scheduled, batch, on-demand, and/or triggered decompilation operations.

### 8.4) Decompiled Output Storage & Interactive Artifact Management

A Machine/Byte Code Decompilation Module 800 may further comprise one or more components configured to store, index, version, retrieve, and/or present Decompiled Outputs 845 in formats suitable for interactive inspection and/or downstream analysis. These components may include, but are not limited to, a Decompiled Interactive File Storage 840.

Decompiled Interactive File Storage 840 may use one or more persistent storage mechanisms to store artifacts including, but not limited to, decompiled source-like code, intermediate representations, metadata describing decompilation confidence and/or provenance, cross-reference information, function boundary mappings, symbol tables, call graphs, control-flow graphs, and/or data-flow graphs. In an example, storage may support interactive workflows including, but not limited to, hyperlink navigation between callers and callees, jump-to-definition, jump-to-reference, semantic search, differential comparisons between versions, and/or annotation of recovered constructs.

Decompiled Interactive File Storage 840 may further store audit and/or provenance records, including, but not limited to, which decompilation strategies were applied, which modules and/or tools were used, which intermediate representations were generated, and/or which transformations were performed, thereby supporting reproducibility, explainability, and/or iterative refinement of decompilation outputs over time.

### 9) Functional Diagram for Notification Module

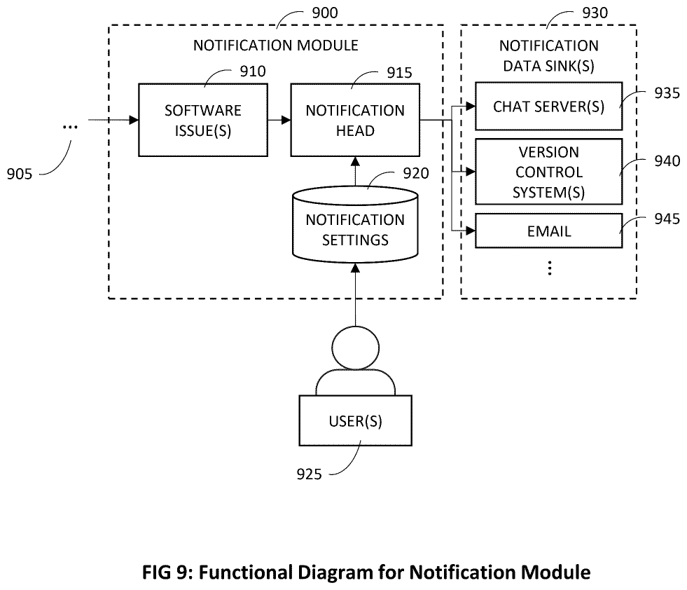

FIG. 9 depicts an exemplary functional diagram illustrating how one or more Software Issue(s) 910 may be formatted, enriched, and/or delivered to zero or more Notification Data Sink(s) 930 by a Notification Module 900, during and/or after agentic analysis. The behavior and/or operation of a Notification Module 900 may be configured, initiated, and/or influenced by one or more User(s) 925.

FIG. 9 may be considered an example of a Notification Module 120 and/or Notification Data Sink(s) 130.

The number, type, arrangement, and order of components shown in FIG. 9 are merely illustrative. Components may be substituted, combined, omitted, rearranged, and/or supplemented in any manner without departing from the scope of the invention.

### 9.1) Notification Module

A Notification Module 900 may receive one or more Software Issue(s) 910 from an Analysis Agent Ensemble 905 and/or from one or more upstream software components of the generative AI-based cybersecurity vulnerability remediation system. The received Software Issue(s) 910 may be stored, cached, and/or otherwise made available for subsequent processing using zero or more persistent storage mechanisms.

A Notification Module 900 may include a Notification Head 915 configured to determine how software issues are processed, formatted, enriched, and/or routed, and/or to identify one or more Notification Data Sink(s) 930 to which notifications may be delivered. One or more User(s) 925 may define, modify, and/or manage one or more Notification Settings 920 that govern operation of a Notification Head 915, including when notifications are generated and/or how notifications are formatted and/or delivered.

### 9.2) Notification Data Sinks

Notification Data Sink(s) 930 may include but are not limited to Chat Server(s) 935, Version Control System(s) 940, and/or Email 945, etc.

### 10) Functional Diagram for Software Issue Remediation Using Symbolic Execution Data

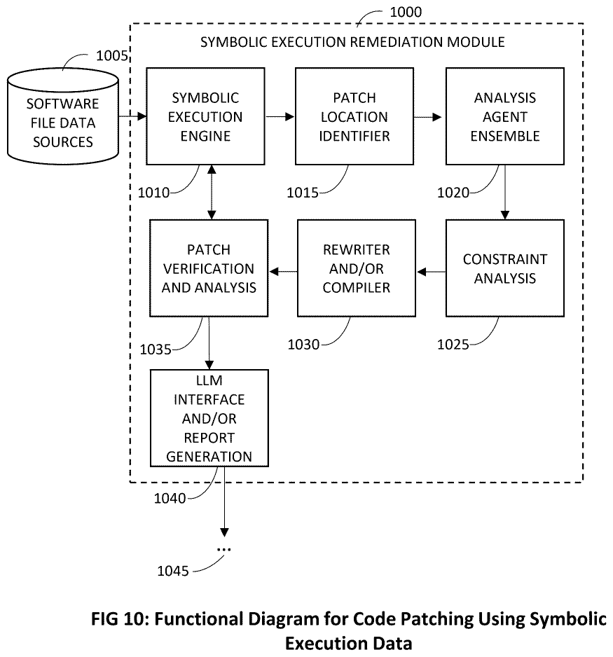

FIG. 10 depicts an exemplary functional diagram illustrating how an example software tool, a Symbolic Execution Engine 1010, may interact with an Analysis Agent Ensemble 1020 and/or other tools to analyze software files, and/or detect and/or remediate vulnerabilities. It may include components, such as, but not limited to, automated code analysis, vulnerability detection, patch generation, and code modification. The behavior and/or operation of a Symbolic Execution Engine 1010 may be configured, initiated, and/or influenced by one or more configurations included in one or more Software File Data Sources 1005, etc.

The behavior and/or operation of a Symbolic Execution Engine 1010 may be configured, initiated, and/or influenced by one or more User(s) 125.

The number, type, arrangement, and order of components shown in FIG. 10 are merely illustrative. Components may be substituted, combined, omitted, rearranged, and/or supplemented in any manner without departing from the scope of the invention.

### 10.1) Symbolic Execution Remediation Module

A Symbolic Execution Remediation Module 1000 may be an example of an AI-based cybersecurity vulnerability remediation. It may be integrated as part of an Analysis Agent Ensemble 1020, may be a software tool within an Analysis Agent Ensemble 1020, and/or may utilize one or more Analysis Agent Ensemble 1020, etc. The objectives pursued by a Symbolic Execution Remediation Module 1000 may vary, but may include but are limited to, detecting software issues, formatting software as an intermediate representation, determining parts of code to prioritize, determining parts of code to remove and/or neglect, refining constraints, determining one or more paths to a software issue, determining one or more callstack for a software issue, simulating memory and/or storage for one or more software file, determining one or more constraint of a software issue, validating one or more patch was successful, generating one or more patch, and/or identifying locations in code to make one or more remediation to a software issue, etc. As an example, this module may apply optimization techniques to determine one or more optimal paths to a software issue.

A Symbolic Execution Remediation Module 1000 may include, but is not limited to, interactions with one or more user interfaces and/or external interfaces associated with other system components, software tools, and/or networks, etc. For example, it may request, receive, or transmit configuration information for symbolic execution from various sources, including but not limited to users, other software applications, databases, knowledge bases, intrusion detection systems (IDS), firewalls, web servers, APIs, services buses, message queues, etc. Users and/or external systems may interact and/or guide the module's behavior before, during, and/or after symbolic analysis, etc. Some interactions may include, but are not limited to, creating, specifying, and/or changing one or more pruning and/or prioritization strategies, setting timeout thresholds to manage execution duration, adjusting the depth of symbolic exploration, changing symbolic states stored in memory and/or on storage, etc., and/or guiding symbolic execution towards specific basic blocks, functions, files, libraries, and/or lines of code, etc.

### 10.2) Software File Data Source(s)

One or more Software File Data Source(s) 1005 may be received by, retrieved by, and/or generated by a Symbolic Execution Remediation Module 1000, etc. It may receive software files at one or more abstraction, such as (but not limited to) intermediate representations, source code, and/or binary files, etc. For example, an intermediate representation may be a symbolic execution supported intermediate representation, such as, but not limited to, VEX and/or ESIL, etc. It may include configuration data, for example (but not limited to), the environment to run symbolic execution in (e.g., a virtual machine, docker container, using a previously registered codebase, and/or version of an operating system, version of shared objects, etc.), environment variables to use during analysis, and/or command-line arguments, etc.

### 10.3) Symbolic Execution Engine

A Symbolic Execution Engine 1010 may interact with at least one software file from a Software File Data Source 1005. It may analyze for one or more software issue. It may analyze failing unit tests and/or perform formal verification. It may be used for confirming test cases, such as, but not limited to, unit tests, performance tests, end-to-end tests, etc.

Symbolic Execution Engine 1010 configurations may include various parameters to customize the analysis process. For example, but not limited to, a configuration may specify how long to run the analysis, including rule-based stopping criteria, such as rules for when to stop the analysis based on time, resource utilization, and/or specific events, etc. For example, an analysis may be stopped based on maximum wall clock time reached, maximum analysis duration, memory usage threshold, disk space limit, and/or discovery of specific vulnerabilities like heap overflow and/or system crashes, etc. Configurations may include specifying what code to avoid, such as lists of excluded code in various forms, basic blocks, files, and/or regions of a file and/or project, etc. Configurations may specify prioritization of analysis focus, such as high-risk functions (e.g., gets, strcpy, memcpy, strcat, sprint, malloc, calloc, realloc, free, memmove, scanf, and/or printf, etc.) and/or frequently used functions, performance-critical code, and/or code with potential concurrency issues.

Configurations may include, but are not limited to specifying what basic blocks to prioritize, and/or which files to analyze. Configurations may specify vulnerability severity threshold for prioritization of various types of vulnerabilities such as heap overflow, stack overflow, null pointer dereference, divide by zero, out-of-bounds reads, and writes. Configurations may include, but are not limited to, specifications on exploration strategies, including prioritization strategies, pruning strategies, and/or merging strategies to optimize the analysis process, etc.

A Symbolic Execution Engine 1010 may include one or more engines, such as, but not limited to, general purpose and/or binary engines (e.g., angr, KLEE, Manticore, S2E, etc.), C/C++ engines (e.g., CREST and/or Otter, etc.), JavaScript engines (SymJS and/or ExpoSE, etc.), and/or Python engines (e.g., PyExZ3 and/or CrossHair), etc. It may include a proprietary symbolic execution engine. It may include one or more versions of a symbolic execution. A type and/or version of a symbolic execution engine may be specified. Multiple engines may be used for comparative analysis and/or concurrently (e.g., to evaluate different exploration approaches). As an example, a software project may contain both C and Python code, and may use an engine for C code and an engine for Python code.

In an example, a Symbolic Execution Engine 1010 may provide one or more intermediate status updates to an Analysis Agent Ensemble 1020. It may provide information, such as, but not limited to, software issues discovered, software issues confirmed, analysis coverage, and/or performance coverage. An engine may, for example, adapt based on feedback provided by an Analysis Agent Ensemble 1020, and/or based on feedback provided by a user, etc. It may provide information, such as exploration being stalled by a loop, recursion, and/or thread, and/or paths it is currently exploring, etc. Feedback provided in response may be used to prioritize a different path, and/or software issue type, etc.

A Symbolic Execution Engine 1010 may provide one or more software issue discovered to a Patch Location Identifier 1015 module. It may provide symbolic execution context data, such as, but not limited to, callstack, paths, Input to reproduce, constraints, memory, description, location, current program state, stack frame, Vulnerability name, CWE name, CWE type, function names, instruction offsets, source code line numbers, and/or files containing vulnerability, etc.

A Symbolic Execution Engine 1010 may save symbolic states of an engine at, before, and/or after a software issue has been countered. It may be used to later reload and save resources having to analyze code after a patch has been provided by a Patch Verification and/or Analysis 1035 module. It may be used to analyze past where software issues were previously after they have been patched. It may analyze for software issues that may have been caused by implementing a patch.

### 10.4) Patch Location Identifier

A Patch Location Identifier 1015 module may receive input from one or more Symbolic Execution Engine 1010. It may receive Software File Data Source(s) 1005 and/or other information from prior steps, such as configurations and/or symbolic execution context data, etc. It may use information received to determine one or more patch locations for one or more software issue. This step may be skipped if no software issues have been detected. A user and/or Analysis Agent Ensemble 1020 may specify what vulnerabilities to prioritize and the locations to prioritize fixes.

It may analyze the impact of patching a single block, function, and/or file, etc., on the overall program behavior. It may output one or more patch locations for one or more software issues to an Analysis Agent Ensemble 1020. It may be optimized based on code structure, vulnerability coverage, and program functionality. A single patch may support remediation of multiple software issues. A Patch Location Identifier 1015 may identify multiple paths to make modifications to in order to patch a single software issue. An output of a Patch Location Identifier 1015 may include metrics, explanations, and/or scoring to indicate the quality of each proposed patch location, etc. It may enable an Analysis Agent Ensemble 1020 to provide high-quality patches with minimal impact on program behavior.

### 10.5) Analysis Agent Ensemble

An Analysis Agent Ensemble 1020 may receive information from prior steps and/or a user, etc. For example, it may be provided software files from Software File Data Sources 1005 and/or patch locations from a Patch Location Identifier 1015, etc. It may perform remediation of one or more files, functions, blocks, and/or configuration files, etc. It may use techniques such as, but not limited to, patching, refactoring, and/or other repair methods, etc.

An Analysis Agent Ensemble 1020 may propose one or more potential patches for one or more identified software issues. It may provide potential patches for one or more identified patch locations. It may provide one patch for multiple identified software issues. It may utilize LLMs to generate patch code. It may consider multiple factors, such as, but not limited to, patch effectiveness, code maintainability, and/or program functionality preservation, etc. It may iterate with other modules, such as, but not limited to, Constraint Analysis 1025 and/or Patch Verification and/or Analysis, etc., for further processing and/or refining proposal(s) based on feedback from ensemble members, etc. It may incorporate new information into a patch strategy. It may output patch proposals to the user, and/or development team for implementation. It may provide output to a Constraint Analysis 1025 module to analyze the impact of proposed patches on function and/or vulnerable constraints, etc.

### 10.7) Constraint Analysis

A Constraint Analysis 1025 module may analyze the constraints of one or more software patches and/or its associated functions, basic blocks, files, libraries, and/or inputs, etc. It may perform comparative analysis before and after a patch has been applied. It may compare the behavior, data flow, and/or control flow of the patched code with that of the original code. It may identify any changes in code metrics, such as complexity and/or security features, etc. It may provide insights into the effectiveness of the patching process.

Results of Constraint Analysis 1025 may determine the impact of one or more proposed patches from an Agent Analysis Ensemble 1020 on specific parts of a software file and/or a full software file and/or software project, etc. It may determine how suitable each patch is for integration. It may provide information back to an Agent Analysis Ensemble 1020 on constraint impact to, for example, further improve patch effectiveness and/or side effects. It may provide one or more outputs, such as, but not limited to, a constraint impact score and/or a ranked list of suitable patches, etc., to a Rewriter and/or Compiler 1030 module.

### 10.8) Rewriter And/or Compiler

A Rewriter and/or Compiler 1030 module may modify one or more software file to produce remediated code. It may apply one or more proposed software issue patch. It may apply transformation rules to, for example, simplify code, reduce redundancy and/or improve maintainability, etc. It may generate optimal binaries by selecting the best strategy to re-compile. It may make changes at one or more abstraction, such as, but not limited to, binary rewriting, source code modifications, changes in intermediate representation, and/or changes to configurations, etc. For example, it may identify changes to binaries arising from LLM-patch combinations and/or inserts patch-blobs accordingly, etc. It may simplify recompilation of affected regions by providing targeted repair templates. It may provide one or more remediated software files to a Patch Verification and/or Analysis 1035 module.

### 10.8) Patch Verification And/or Analysis

A Patch Verification and/or Analysis 1035 module may, for example, ensure that patches are effective and/or do not introduce new issues, etc. It may receive user-provided remediated code and/or automated modified code from a Rewriter and/or Compiler 1030 module. It may be analyzed to verify the effectiveness of the patch and/or its side effects using a Symbolic Execution 1010 engine. This process may involve iterating with an Analysis Agent Ensemble and/or one or more users to test new and/or other patches, etc.

A Patch Verification and/or Analysis 1035 module may verify that each patch successfully addresses the software issue it intended to. It may analyze relationships between patches and/or nearby code to identify potential issues and/or may load constraints to analyze the code at a block and/or function level, etc. It may continue analysis, such as (but not limited to) a Symbolic Execution Engine 1010 to identify downstream code affected by one or more patch. It may quantify the impact of each patch on overall program behavior. It may ensure that patches are thorough, reliable, and efficient in remediating software issues. It may provide information to an LLM Interface and/or Report Generation 1040 to communicate results and/or impact, etc., of one or more patches applied.

10.9) LLM Interface and/or Report Generation

An LLM Interface and/or Report Generation 1040 module may integrate and/or communicate information from one or more other modules. It may provide a comprehensive interface for exploring vulnerability detection, patch generation, and/or code modification results, etc. It may generate reports that summarize key findings, including vulnerability counts and/or severity ratings, patch effectiveness and/or success metrics, and/or code metrics such as complexity and/or security features, etc. It may provide visualizations of the relationships between vulnerabilities and/or patches, using charts, graphics, and/or tables to facilitate understanding and/or interpretation, etc. It may offer recommendations for further improvements, ways to avoid a software issue found in the future, and/or how to write and/or structure software to make a software issue easier to remediate, etc. It may include a prioritized list of vulnerabilities to focus on next and/or targeted code improvements and/or restructuring suggestions, etc.

In an example, an LLM Interface and/or Report Generation 1040 module may receive one or more Software File Data Source 1005 before it is provided to a Symbolic Execution Engine 1040. An LLM Interface and/or Report Generation 1040 module may generate a configuration file, may prompt the user and/or Analysis Agent Ensemble 1020 for missing and/or flagged configuration fields, may suggest configurations (e.g., based on project, based on prior analysis, results from other tools, vulnerability database data and/or pre-processing analyses, etc.). It may prompt for code to get analyzed, such as, but not limited to, requesting code written in the interface, uploading code, providing paths, and/or copy-pasting parts of code, etc.

Symbolic Execution Remediation Module Outputs 1045 may be provided as a notification. It may include alignment with secure coding guidelines and/or standards, etc. It may incorporate user feedback and/or insights to refine LLM Interface and/or Report Generation 1040 capabilities.

### 11)component(s) of UI/UX for Agentic Analysis Home Page

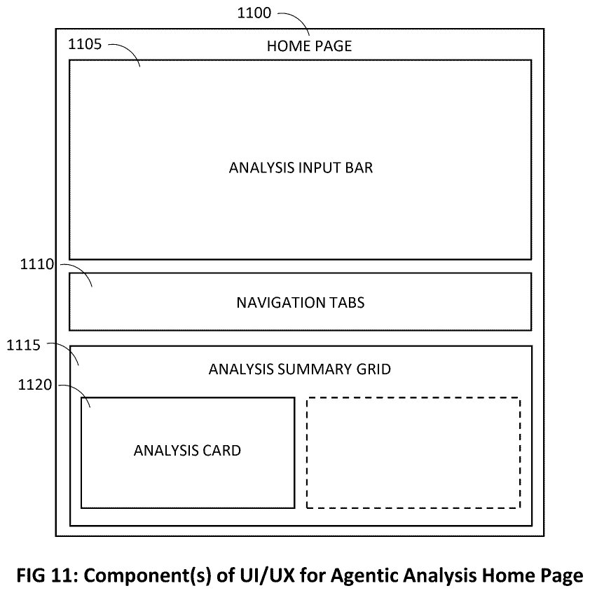

FIG. 11 depicts an exemplary user interface for a Home Page 1100 and/or agentic analysis entry point. A Home Page 1100 may serve as an interface through which users initiate new agentic analyses and/or review past analysis sessions.

FIG. 11 may be an example user interface for interacting with one or more analysis agent ensembles and/or for viewing zero or more software issues identified during an agentic analysis.

The number, type, arrangement, and order of components shown in FIG. 11 are merely illustrative. Components may be substituted, combined, omitted, rearranged, and/or supplemented in any manner without departing from the scope of the invention.

### 11.1) Analysis Input Bar

A Home Page 1100 may include an Analysis Input Bar 1105, which may comprise a horizontal bar and/or container holding some or all input elements required for initiating an agentic analysis. An Analysis Input Bar 1105 may comprise, but is not limited to:
an initial user prompt text input field for entering a natural language description of an agentic analysis to perform (e.g., “Review authentication flow for SQL injection vulnerabilities”, “Scan for hardcoded credentials”, etc.);
a software file data source selection dropdown for choosing which software file data source to analyze (e.g., version control systems, local file systems, network file systems, etc.);
a branch selection dropdown for choosing which branch and/or version of software to analyze. Branch selection may support, but is not limited to, listing available branches from a connected version control system, searching and/or filtering branches by name, and/or displaying branch metadata (e.g., last commit, author, etc.), etc.;
an analysis agent ensemble dropdown for choosing which ensemble implementation(s) to use for agentic analysis; and/or,
a submit button that initiates the analysis when activated.

### 11.2) Navigation Tabs

A Home Page 1100 may include Navigation Tabs 1110, which may comprise clickable tabs which allow users to alternate between different content views. Navigation Tabs 1110 may include, but are not limited to:
an analyses tab for viewing a list of past and/or current agentic analyses; and/or
an issues tab for viewing aggregated software issues across some or all agentic analyses.

### 11.3) Analysis Summary Grid

A Home Page 1100 may include an Analysis Summary Grid 1115, which may comprise a grid layout displaying one or more Analysis Cards 1120 in a responsive and/or organized arrangement. An Analysis Summary Grid 1115 may present historical analyses and/or allow users to browse, select, and/or navigate to specific agentic analysis views, etc.

An Analysis Card 1120 may present analysis metadata and/or summary information associated with an agentic analysis session. An Analysis Card 1120 may serve as an interactive element, allowing users to navigate to a corresponding analysis chat interface on click.

An Analysis Card 1120 may comprise, but is not limited to:
some or all of an initial user prompt and/or human-readable summary describing the agentic analysis performed;
a timestamp indicating when the agentic analysis was started and/or finished;
a hyperlink and/or text representing the software file(s) and/or software file data source(s) analyzed (e.g., a hyperlink to a specific version control repository, etc.);
a badge and/or text representing the number and/or severity of software issues identified during and/or after the agentic analysis.

### 12) Component(s) of UI/UX for Agentic Analysis Chat Interface and Issue Detail Page

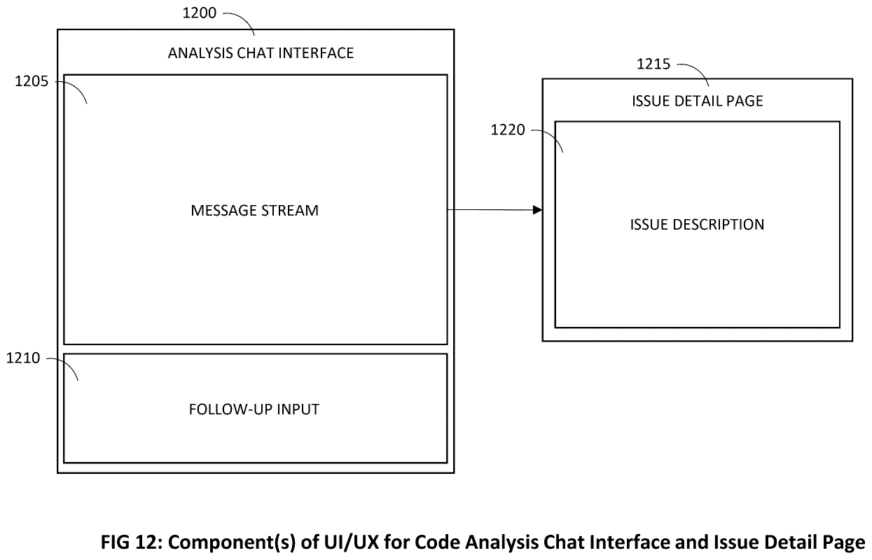

FIG. 12 depicts an exemplary user interface for conducting interactive agentic analysis conversations and/or viewing software issue details.

The number, type, arrangement, and order of components shown in FIG. 12 are merely illustrative. Components may be substituted, combined, omitted, rearranged, and/or supplemented in any manner without departing from the scope of the invention.

### 12.1) Analysis Chat Interface

An Analysis Chat Interface 1200 may display real-time streaming updates in relation to a message history and/or agentic analysis. An Analysis Chat Interface 1200 may support turn-based interaction patterns. An Analysis Chat Interface 1200 may comprise, but is not limited to, a Message Stream 1205 and/or a Follow-Up Input 1210.

A Message Stream 1205 may comprise a scrollable container presenting a chronological sequence of analysis messages exchanged during an agentic analysis. A Message Stream 1205 may include, but is not limited to, the following message types:
AI messages which may contain analysis agent ensemble and/or LLM interface responses with support for embedded content;
tool messages showing software analysis tool invocations and/or results (e.g., issue reporting tools, file read operations, directory tree displays, etc.);
system messages providing software context, software file data source information, analysis status updates, etc.; and/or
human messages containing user queries, initial user prompts, follow-up questions, etc.

A Message Stream 1205 may further include clickable links enabling navigation to an Issue Detail Page 1215 for reported software issues. Messages within a Message Stream 1205 may be rendered with markdown formatting, syntax highlighting, severity badges, and/or other visual indicators.

A Follow-Up Input 1210 may comprise a container for user input elements used to send additional queries during and/or after agentic analysis. A Follow-Up Input 1210 may comprise, but is not limited to:
a text input field for entering follow-up messages, questions, analysis refinements, etc.; and/or
a send button that transmits the message to a message history, LLM interface, and/or analysis agent ensemble.

### 12.2) Issue Detail Page

An Issue Detail Page 1215 may provide details related to one or more software issues identified during agentic analysis. An Issue Detail Page 1215 may be accessible via hyperlinks and/or other clickable components within a Message Stream 1205. An Issue Detail Page 1215 may contain an Issue Description 1220 and/or other relevant issue information, etc.

An Issue Description 1220 may comprise a container displaying comprehensive software issue information. An Issue Description 1220 may comprise, but is not limited to:
an issue title and/or summary describing the detected software issue;
a severity badge showing the severity level of the issue (e.g., minor, moderate, major, etc.);
a code snippet displaying the relevant source code with syntax highlighting and/or line number references;
a detailed explanation text describing the software issue and/or its potential impact; and/or
recommended mitigation and/or remediation steps for addressing the issue.

### 13) Component(s) of UI/UX for Event Setting Configuration

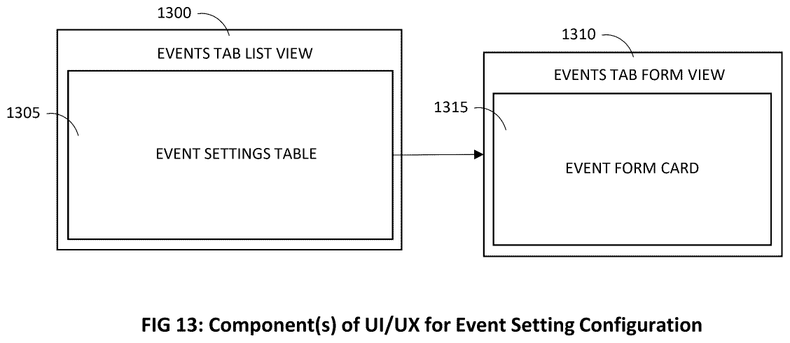

FIG. 13 depicts an exemplary user interface for configuring event settings. Configuring event settings may enable users to define automated software ingestion triggers based on events in one or more software data sources.

The number, type, arrangement, and order of components shown in FIG. 13 are merely illustrative. Components may be substituted, combined, omitted, rearranged, and/or supplemented in any manner without departing from the scope of the invention.

### 13.1) Events Tab List View

An Events Tab List View 1300 may enable users to browse, select, and/or manage existing event setting configurations. An Events Tab List View 1300 may comprise, but is not limited to, action buttons for adding new event settings and/or an Event Settings Table 1305.

An Event Settings Table 1305 may comprise a data table presenting configured event settings. An Event Settings Table 1305 may include, but is not limited to, the following columns:
an event type column indicating the software data source event type (e.g., commit, pull request, etc.);
a branch column showing a configured version control branch pattern;
an initial user prompt column; and/or,
action buttons for add, edit, and/or delete operations.

An Event Settings Table 1305 may further include pagination controls for browsing through multiple event setting configurations. Clicking a row within an Event Settings Table 1305 may navigate to an Events Tab Form View 1310 for editing the selected event setting.

### 13.2) Events Tab Form View

An Events Tab Form View 1310 may be displayed upon selecting an existing event setting row and/or clicking an add event setting button, etc. An Events Tab Form View 1310 may comprise, but is not limited to, an Event Form Card 1315 for creating and/or editing an event setting.

An Event Form Card 1315 may contain event setting configuration input fields. An Event Form Card 1315 may comprise, but is not limited to:
explanatory text describing how event settings trigger automatic software ingestion;
an event type selector for choosing the type of software file data source event to monitor (e.g., commit, pull request, etc.) and/or descriptive help text;
a version control branch name input field for specifying which branch to monitor, wherein an empty value may serve as a wildcard matching all branches;
a text area for defining an initial user prompt to incorporate into an agentic analysis when an event is triggered; and/or,
a submit button for persisting the event setting configuration.

### 14) Component(s) of UI/UX for Notification Setting Configuration

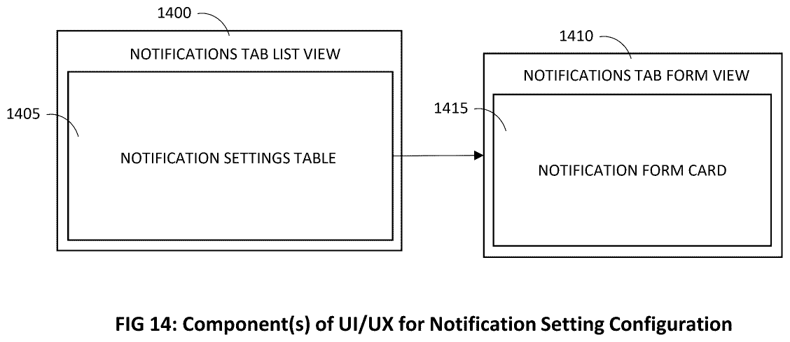

FIG. 14 depicts an exemplary user interface for configuring notification settings. Configuring notification settings may enable users to define notification data sinks and/or other parameters for distributing notifications related to detected software issues.

The number, type, arrangement, and order of components shown in FIG. 14 are merely illustrative. Components may be substituted, combined, omitted, rearranged, and/or supplemented in any manner without departing from the scope of the invention.

### 14.1) Notifications Tab List View

A Notifications Tab List View 1400 may enable users to browse, select, and/or manage existing notification setting configurations. A Notifications Tab List View 1400 may comprise, but is not limited to, action buttons for adding new notification settings and/or a Notification Settings Table 1405.

A Notification Settings Table 1405 may comprise a data table presenting configured notification settings. A Notification Settings Table 1405 may include, but is not limited to, the following columns:
a notification name and/or summary column describing a configured notification data sink;
a notification type column indicating the notification data sink type (e.g., email, Slack, HTTP POST request, etc.);
a conditions column indicating when notifications should be delivered to the configured notification data sink; and/or
action buttons for add, edit, and/or delete operations.

A Notification Settings Table 1405 may further include pagination controls for browsing through multiple notification setting configurations. Clicking a row within a Notification Settings Table 1405 may navigate to a Notifications Tab Form View 1410 for editing the selected notification setting.

### 14.2) Notifications Tab Form View

A Notifications Tab Form View 1410 may be displayed upon selecting an existing notification setting row and/or clicking an add notification setting button, etc. A Notifications Tab Form View 1410 may comprise, but is not limited to, a Notification Form Card 1415 for creating and/or editing a notification setting.

A Notification Form Card 1415 may contain notification setting configuration input fields. A Notification Form Card 1415 may comprise, but is not limited to:
explanatory text describing how notification settings work and/or how notifications are triggered when software issues are detected;
a notification type selector for choosing the notification data sink type (e.g., email, Slack, HTTP POST request, etc.) with descriptive help text;
type-specific configuration input fields that appear dynamically based on the selected notification type (e.g., notification data sink credentials, URLs, recipient addresses, etc.);
a conditions selector for defining when notifications should be delivered to the configured notification data sink; and/or,
a submit button for persisting the notification setting configuration.

### 15) Flowchart for Generative AI-Based Cybersecurity Vulnerability Remediation Method

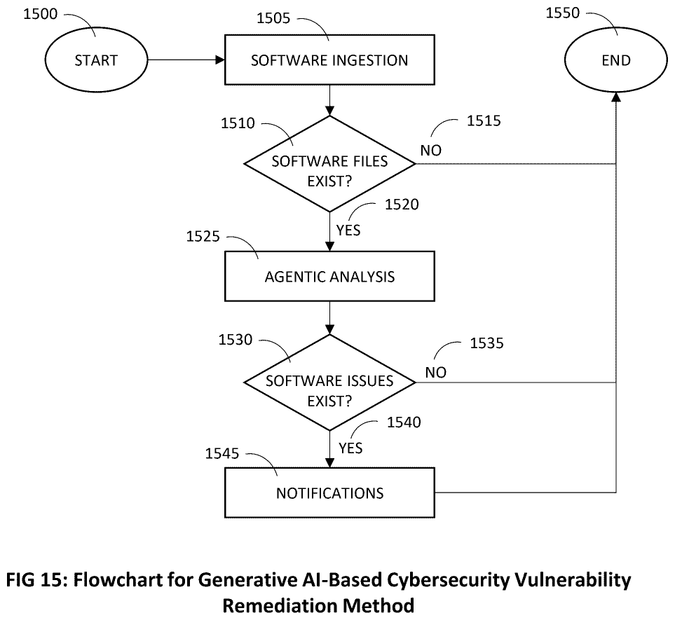

FIG. 15 depicts an exemplary flowchart illustrating a generative AI-based cybersecurity vulnerability remediation method. The method may include Software Ingestion 1505, Agentic Analysis 1525, and/or Notifications 1545. The behavior and/or operation of the method may be configured, initiated, and/or influenced by one or more users and/or automated system components.

The number, type, arrangement, and order of components shown in FIG. 15 are merely illustrative. Components may be substituted, combined, omitted, rearranged, and/or supplemented in any manner without departing from the scope of the invention.

### 15.1) Software Ingestion

A generative AI-based cybersecurity vulnerability remediation method may begin at Start 1500 by performing Software Ingestion 1505. Software Ingestion 1505 may include ingesting zero or more software files from one or more software file data sources and/or storing any ingested software files in analysis file storage.

The method may then determine, at decision step Software Files Exist? 1510, whether one or more software files have been ingested. If Yes 1520, the method proceeds to perform Agentic Analysis 1525. If No 1515, indicating that no software files were ingested, the method may terminate at End 1550 without performing further analysis.

### 15.2) Agentic Analysis

The generative AI-based cybersecurity vulnerability remediation method may perform Agentic Analysis 1525 on one or more ingested software files using one or more analysis agent ensembles to identify, detect, infer, and/or report zero or more software issues. Agentic analysis may be performed in a single pass or across multiple passes and may include accessing, querying, and/or interacting with analysis file storage one or more times, including through direct file access, database queries, and/or invocation of one or more software analysis tools.

The method may determine, at decision step Software Issues Exist? 1530, whether one or more software issues have been identified. If Yes 1540, the method proceeds to deliver Notifications 1545. If No 1535, indicating that no software issues were identified, the method may terminate at End 1550 without delivering notifications (or for example delivering one or more notifications stating that no software issues were identified).

### 15.3) Notifications

The generative AI-based cybersecurity vulnerability remediation method may deliver Notifications 1545 associated with one or more identified software issues. Prior to delivery, the identified software issues may be processed, enriched, aggregated, and/or formatted to generate one or more notifications.

The notifications may then be delivered to one or more notification data sinks, after which the method may terminate at End 1550, having reported software issues detected in the ingested software files.

What is claimed is:

1. A method for analyzing software issues of at least one computer software comprised in at least one computing system, the method comprising:
loading, via a processor, from a data storage, a memory, or via a communication device, or via a user entry through a user interface, at least one software file;
receiving, via the processor, at least one configuration input data associated with configuration settings and preferences;
modifying, via the processor, the structure of the at least one loaded software file for at least one analysis agent ensemble;
executing, via the processor, at least one iteration of at least one analysis agent ensemble on at least one modified software file using the received at least one configuration input data;
identifying, via the processor, at least one potential software issue found through execution of the at least one iteration of the at least one analysis agent ensemble on the at least one modified software file;
determining, via the processor, options to remediate the at least one potential software issue through at least one of: automated updates, guided remediation steps, or a combination thereof;
delivering, via the processor, the at least one potential software issue and options to remediate the at least one potential software issues to at least one output interface.

2. The method according to claim 1, wherein loading at least one software file comprises at least one of an entire software project, a subset of a project, multiple projects, one or more individual files, portions of a firmware image, specific binaries, shared objects, or entire file systems.

3. The method according to claim 1, wherein loading the at least one software file comprises loading, as input, at least one document file from at least one of: a version control system including Git, GitHub, GitLab, Bitbucket, Subversion (SVN), Perforce, or Mercurial; a local file system, including NTFS, ext4, FAT32, APFS, or XFS; a network file system including Network File System (NFS), Server Message Block (SMB), Amazon S3, Google Cloud Storage, Azure Blob Storage, or WebDAV; an object storage service; an artifact repositories; a container registries; a persistent storage mechanism; a continuous integration or continuous delivery (CI/CD) pipeline; a build system; a package manager; or a backup system.

4. The method according to claim 1, wherein loading a software file comprises receiving, as input, one or more files having file formats selected from: binary files including executable machine code in architectures comprising at least one of x86, ARM, MIPS, or RISC-V; dynamically linked libraries, including . dll, . so, statically linked executables, or firmware images; source code files including languages comprising at least one of C, C++, BASIC, Java, Pascal, Python, PHP, Ruby, Bash, Perl, Prolog, Datalog, Scala, Haskell, Rust, or assembly language; immediate representation including VEX, LLVM Intermediate Representation (LLVM IR), Java bytecode, Multi-Level Intermediate Representation (MLIR), ESIL, Binary Analysis Platform (BAP) or Intermediate Language (BIL); compressed file including .zip, .rar, .tar, .gz, .xz, .7z, or file system exports; vulnerability database records, including historical or current vulnerability records, comprising at least one of the National Vulnerability Database (NVD), or Common Vulnerabilities or Exposures (CVE), vulnerability taxonomies, classifications, comprising at least one Common Weakness Enumeration (CWE), exploitability; or threat intelligence indicators, comprising at least one Known Exploited Vulnerabilities (KEV); severity metrics; remediation guidance; metadata; or correlations among vulnerabilities, build artifacts, or metadata files.

5. The method according to claim 1, wherein receiving the at least one configuration input data associated with configuration settings and preferences comprise at least one of: environment variables; command-line arguments; configuration values provided through a user interface; configuration values supplied via an application programming interface (API); or configuration files including .cfg, .ini, .json, .yaml, .yml, .xml, .env, or .txt.

6. The method according to claim 1, wherein modifying the structure of the at least one loaded software file for at least one analysis agent ensemble comprises at least one of: pre-processing operations including filtering files deemed irrelevant for subsequent agentic analysis like those based on file size or file type; modifying directory structures; renaming files; or removing, adding, or modifying file contents.

7. The method according to claim 1 wherein the at least one iteration of at least one analysis agent ensemble comprises at least one of: software component configured to analyze at least one software file to identify, detect, or report the at least one potential software issue including at least one of LLM interfaces, message histories, software analysis tools, pre-processing components, post-processing components, or persistent data storage mechanisms.

8. The method according to claim 1, wherein the at least one analysis agent ensemble is implemented using an architecture comprising at least one of software tools, file-navigation-based analysis, retrieval-augmented generation (RAG), iterative function analysis, control-flow analysis, or data-flow analysis.

9. The method according to claim 8, wherein software tools comprise at least one software component, mechanism, service, function, or executable program that is invoked, security-focused analysis that directly produces security-related information, including software vulnerabilities, weaknesses, or risk indicators, or indirectly supports security analysis by producing intermediate or contextual information.

10. The method according to claim 8, wherein software tools may be invoked with inputs comprising at least one of target files, target file paths, analysis scope, timeout values, search criteria, vulnerability categories, execution constraints, or configuration options.

11. The method according to claim 1 wherein identifying the at least one potential software issue comprises at least one of: cybersecurity vulnerability including memory safety errors, stack-based buffer overflows, heap-based buffer overflows, use-after-free conditions, double frees, out-of-bounds reads or writes, or null pointer dereferences; injection vulnerability, comprising at least one SQL injection, command injection, code injection, or cross-site scripting (XSS); authentication or authorization flaws, comprising at least one improper access control, privilege escalation, broken authentication, or insecure session management; cryptographic weakness, comprising at least one use of weak or deprecated algorithms, improper key management, hard-coded secrets, insufficient entropy, or insecure randomness; input validation or data handling issue, including improper sanitization, unsafe deserialization, or unchecked user input; concurrency or logic error, comprising at least one race conditions, deadlocks, time-of-check to time-of-use (TOCTOU) issues, or flawed control flow; dependency or supply-chain issue, including vulnerable third-party libraries, outdated dependencies, license incompatibilities, or unverified artifacts; configuration or deployment issue, comprising at least one insecure default settings, exposed credentials, excessive permissions, or misconfigured services; code quality or maintainability issue, including dead code, unreachable code, duplicated logic, excessive complexity, poor error handling, resource leaks, performance bottlenecks, or violations of coding standards or best practices.

12. The method according to claim 11, wherein the at least one potential software issue comprises supplementary data, including at least one of descriptions, titles, summaries, code snippets, patched code, remediation or mitigation advice, severity levels, hyperlinks, references to at least one software file or software file data source, or related vulnerability database entries, comprising at least one related CVEs or CWEs.

13. The method according to claim 7, wherein the at least one persistent data storage mechanism store at least one software file, software issue, event setting, notification setting, analysis message, vulnerability data remediation artifact, metadata, analysis result, or other data relevant to a generative AI-based cybersecurity vulnerability remediation system; wherein the at least one persistent storage mechanism comprises at least one relational database, comprising at least one PostgreSQL or MySQL, non-relational database, comprising at least one MongoDB or Cassandra, file system, object storage system, key-value store, data warehouse, vector database, or any combinations thereof.

14. The method according to claim 1 wherein the options to remediate the at least one potential software issue comprise at least one of providing patches, automated fixes, manual steps, or instructions for addressing vulnerabilities, including remediation plans, configuring firewall rules, implementing vulnerability scanning, employing security auditing, performing code reviews, conducting risk assessments, applying hotfixes, generating remediation scripts, issuing bug bounty notifications, or deploying anti-malware solutions.

15. The method according to claim 1 wherein the at least one output interface comprises a destination, endpoint, interface, or system, wherein notifications may be transmitted, published, or stored before or after agentic analysis, including at least one of: user interfaces; project management systems including Jira, GitHub Issues, GitLab Issues, Azure DevOps, ServiceNow, Asana, or Trello;
communication platforms including email systems, chat or messaging applications, collaboration platforms, or notification services; version control systems, comprising at least one Git, GitHub, GitLab, Bitbucket, Subversion (SVN), Perforce, or Mercurial; local file systems, comprising at least one NTFS, ext4, FAT32, APFS, or XFS; network file systems, comprising at least one Network File System (NFS), Server Message Block (SMB), Amazon S3, Google Cloud Storage, Azure Blob Storage, or WebDAV; application programming interfaces (APIs); web requests, comprising at least one HTTP requests, HTTPS requests, RESTful API calls, GraphQL requests, webhooks, remote procedure calls (RPCs), TCP, or UDP; integrated development environments (IDEs), comprising at least one Visual Studio Code, IntelliJ IDEA, Eclipse, Visual Studio, Xcode, PyCharm; logging systems; ticketing systems; dashboards, CI/CD systems; or software build systems.

16. A system for analyzing software issues of at least one computer software comprised in at least one computing system, the system comprising:
loading, via a processor, from a data storage, a memory, or via a communication device, or via a user entry through a user interface, at least one software file;
receiving, via the processor, at least one configuration input data associated with configuration settings and preferences;
modifying, via the processor, the structure of the at least one loaded software file for at least one analysis agent ensemble;
executing, via the processor, at least one iteration of at least one analysis agent ensemble on at least one modified software file using the received at least one configuration input data;
identifying, via the processor, at least one potential software issue found through execution of the at least one iteration of the at least one analysis agent ensemble on the at least one modified software file;
determining, via the processor, options to remediate the at least one potential software issue through at least one of: automated updates, guided remediation steps, or a combination thereof;
delivering, via the processor, the at least one potential software issue and options to remediate the at least one potential software issues to at least one output interface.

17. The system according to claim 16, wherein loading at least one software file comprises at least one of an entire software project, a subset of a project, multiple projects, one or more individual files, portions of a firmware image, specific binaries, shared objects, or entire file systems.

18. The system according to claim 16, wherein loading the at least one software file comprises loading, as input, at least one document file from at least one of: a version control system including Git, GitHub, GitLab, Bitbucket, Subversion (SVN), Perforce, or Mercurial; a local file system, including NTFS, ext4, FAT32, APFS, or XFS; a network file system including Network File System (NFS), Server Message Block (SMB), Amazon S3, Google Cloud Storage, Azure Blob Storage, or WebDAV; an object storage service; an artifact repositories; a container registries; a persistent storage mechanism; a continuous integration or continuous delivery (CI/CD) pipeline; a build system; a package manager; or a backup system.

19. The system according to claim 16, wherein loading a software file comprises receiving, as input, one or more files having file formats selected from: binary files including executable machine code in architectures comprising at least one of x86, ARM, MIPS, or RISC-V; dynamically linked libraries, including . dll, . so, statically linked executables, or firmware images; source code files including languages comprising at least one of C, C++, BASIC, Java, Pascal, Python, PHP, Ruby, Bash, Perl, Prolog, Datalog, Scala, Haskell, Rust, or assembly language; immediate representation including VEX, LLVM Intermediate Representation (LLVM IR), Java bytecode, Multi-Level Intermediate Representation (MLIR), ESIL, Binary Analysis Platform (BAP) or Intermediate Language (BIL); compressed file including .zip, .rar, .tar, .gz, .xz, .7z, or file system exports; vulnerability database records, including historical or current vulnerability records, comprising at least one of the National Vulnerability Database (NVD), or Common Vulnerabilities or Exposures (CVE), vulnerability taxonomies, classifications, comprising at least one Common Weakness Enumeration (CWE), exploitability; or threat intelligence indicators, comprising at least one Known Exploited Vulnerabilities (KEV); severity metrics; remediation guidance; metadata; or correlations among vulnerabilities, build artifacts, or metadata files.

20. The system according to claim 16, wherein receiving the at least one configuration input data associated with configuration settings and preferences comprise at least one of: environment variables; command-line arguments; configuration values provided through a user interface; configuration values supplied via an application programming interface (API); or configuration files including .cfg, .ini, .json, .yaml, .yml, .xml, .env, or .txt.

21. The system according to claim 16, wherein modifying the structure of the at least one loaded software file for at least one analysis agent ensemble comprises at least one of: pre-processing operations including filtering files deemed irrelevant for subsequent agentic analysis like those based on file size or file type; modifying directory structures; renaming files; or removing, adding, or modifying file contents.

22. The system according to claim 16 wherein the at least one iteration of at least one analysis agent ensemble comprises at least one of: software component configured to analyze at least one software file to identify, detect, or report the at least one potential software issue including at least one of LLM interfaces, message histories, software analysis tools, pre-processing components, post-processing components, or persistent data storage mechanisms.

23. The system according to claim 16, wherein the at least one analysis agent ensemble is implemented using an architecture comprising at least one of software tools, file-navigation-based analysis, retrieval-augmented generation (RAG), iterative function analysis, control-flow analysis, or data-flow analysis.

24. The system according to claim 23, wherein software tools comprise at least one software component, mechanism, service, function, or executable program that is invoked, security-focused analysis that directly produces security-related information, including software vulnerabilities, weaknesses, or risk indicators, or indirectly supports security analysis by producing intermediate or contextual information.

25. The system according to claim 23, wherein software tools may be invoked with inputs comprising at least one of target files, target file paths, analysis scope, timeout values, search criteria, vulnerability categories, execution constraints, or configuration options.

26. The system according to claim 16 wherein identifying the at least one potential software issue comprises at least one of: cybersecurity vulnerability including memory safety errors, stack-based buffer overflows, heap-based buffer overflows, use-after-free conditions, double frees, out-of-bounds reads or writes, or null pointer dereferences; injection vulnerability, comprising at least one SQL injection, command injection, code injection, or cross-site scripting (XSS); authentication or authorization flaws, comprising at least one improper access control, privilege escalation, broken authentication, or insecure session management; cryptographic weakness, comprising at least one use of weak or deprecated algorithms, improper key management, hard-coded secrets, insufficient entropy, or insecure randomness; input validation or data handling issue, including improper sanitization, unsafe deserialization, or unchecked user input; concurrency or logic error, comprising at least one race conditions, deadlocks, time-of-check to time-of-use (TOCTOU) issues, or flawed control flow; dependency or supply-chain issue, including vulnerable third-party libraries, outdated dependencies, license incompatibilities, or unverified artifacts; configuration or deployment issue, comprising at least one insecure default settings, exposed credentials, excessive permissions, or misconfigured services; code quality or maintainability issue, including dead code, unreachable code, duplicated logic, excessive complexity, poor error handling, resource leaks, performance bottlenecks, or violations of coding standards or best practices.

27. The system according to claim 26, wherein the at least one potential software issue comprises supplementary data, including at least one of descriptions, titles, summaries, code snippets, patched code, remediation or mitigation advice, severity levels, hyperlinks, references to at least one associated software file or software file data source, or related vulnerability database entries, comprising at least one related CVEs or CWEs.

28. The system according to claim 22, wherein the at least one persistent data storage mechanism store at least one software file, software issue, event setting, notification setting, analysis message, vulnerability data remediation artifact, metadata, analysis result, or other data relevant to a generative AI-based cybersecurity vulnerability remediation system; wherein the at least one persistent storage mechanism comprises at least one relational database, comprising at least one PostgreSQL or MySQL, non-relational database, comprising at least one MongoDB or Cassandra, file system, object storage system, key-value store, data warehouse, vector database, or any combinations thereof.

29. The system according to claim 16 wherein the options to remediate the at least one potential software issue comprise at least one of providing patches, automated fixes, manual steps, or instructions for addressing vulnerabilities, including remediation plans, configuring firewall rules, implementing vulnerability scanning, employing security auditing, performing code reviews, conducting risk assessments, applying hotfixes, generating remediation scripts, issuing bug bounty notifications, or deploying anti-malware solutions.

30. The system according to claim 16 wherein the at least one output interface comprises a destination, endpoint, interface, or system, wherein notifications may be transmitted, published, or stored before or after agentic analysis, including at least one of: user interfaces; project management systems including Jira, GitHub Issues, GitLab Issues, Azure DevOps, ServiceNow, Asana, or Trello; communication platforms including email systems, chat or messaging applications, collaboration platforms, or notification services; version control systems, comprising at least one Git, GitHub, GitLab, Bitbucket, Subversion (SVN), Perforce, or Mercurial; local file systems, comprising at least one NTFS, ext4, FAT32, APFS, or XFS; network file systems, comprising at least one Network File System (NFS), Server Message Block (SMB), Amazon S3, Google Cloud Storage, Azure Blob Storage, or WebDAV; application programming interfaces (APIs); web requests, comprising at least one HTTP requests, HTTPS requests, RESTful API calls, GraphQL requests, webhooks, remote procedure calls (RPCs), TCP, or UDP; integrated development environments (IDEs), comprising at least one Visual Studio Code, IntelliJ IDEA, Eclipse, Visual Studio, Xcode, PyCharm; logging systems; ticketing systems; dashboards, CI/CD systems; or software build systems.
